(19) United States
(12) Patent Application Publication
(10) Pub. No.: US 2010/0155330 A1
(43) Pub. Date: Jun. 24, 2010

(54) TARGET MATERIAL REMOVAL USING RARE EARTH METALS

(75) Inventors: John Burba, Parker, CO (US); Carl Hassler, Gig Harbor, WA (US); Joseph Pascoe, Las Vegas, NV (US); Brandt Wright, Henderson, NV (US); Charles Whitehead, Henderson, NV (US); Joseph Lupo, Henderson, NV (US); Conrad Brock O'Kelley, Las Vegas, NV (US); Robert Cable, Las Vegas, NV (US)

Correspondence Address: SHERIDAN ROSS PC, 1560 BROADWAY, SUITE 1200, DENVER, CO, 80202, US

(73) Assignee: MOLYCORP MINERALS, LLC, Greenwood Village, CO (US)

(21) Appl. No.: 12/616,653

(22) Filed: Nov. 11, 2009

Related U.S. Application Data
(60) Provisional application No. 61/113,435, filed on Nov. 11, 2008.
(60) Provisional application No. 61/179,622, filed on May 19, 2009.
(60) Provisional application No. 61/186,258, filed on Jun. 11, 2009.
(60) Provisional application No. 61/186,662, filed on Jun. 12, 2009.
(60) Provisional application No. 61/223,222, filed on Jul. 6, 2009.
(60) Provisional application No. 61/223,608, filed on Jul. 7, 2009.
(60) Provisional application No. 61/224,316, filed on Jul. 9, 2009.
(60) Provisional application No. 61/232,702, filed on Aug. 10, 2009.
(60) Provisional application No. 61/232,703, filed on Aug. 10, 2009.
(60) Provisional application No. 61/240,867, filed on Sep. 9, 2009.

(51) Int. Cl. C02F 1/42; C09K 3/00

(52) U.S. Cl. 210/638; 252/184

(57) ABSTRACT

The present invention is directed to the removal of one or more selected target materials from various streams using a rare earth metal-containing fixing agent.

### CROSS REFERENCE TO RELATED APPLICATION

The present application claims the benefits of U.S. Provisional Application Ser. No. 61/113,435, filed Nov. 11, 2008, entitled “Arsenic Removal Using Rare Earth Metals”; U.S. Provisional Application Ser. No. 61/179,622, filed May 19, 2009, entitled “Arsenic Removal Using Rare Earth Metals”; U.S. Provisional Application Ser. No. 61/186,258, filed Jun. 11, 2009, entitled “Arsenic Removal Using Rare Earth Metals”; U.S. Provisional Application Ser. No. 61/186,662, filed Jun. 12, 2009, entitled “Arsenic Removal Using Rare Earth Metals”; U.S. Provisional Application Ser. No. 61/223,222, filed Jul. 6, 2009, entitled “Arsenic Removal Using Rare Earth Metals”; U.S. Provisional Application Ser. No. 61/223,608, filed Jul. 7, 2009, entitled “Arsenic Removal Using Rare Earth Metals”; U.S. Provisional Application Ser. No. 61/240,867, filed Sep. 9, 2009, entitled “Arsenic Removal Using Rare Earth Metals”; U.S. Provisional Application Ser. No. 61/224,316, filed Jul. 9, 2009, entitled “Removal of Soluble Arsenic from a Sulfide Waste Stream”; U.S. Provisional Application Ser. No. 61/232,702, filed Aug. 10, 2009, entitled “Lanthanide-Based Compound for Arsenic Removal in Sulfide Waste Stream”; and U.S. Provisional Application Ser. No. 61/232,703, filed Aug. 10, 2009, entitled “Aluminum-Induced Precipitation for Arsenic Removal in Sulfide Waste Stream”; which are all incorporated herein by this reference in their entirety.

Cross reference is made to U.S. patent application Ser. Nos. 11/958,602, filed Dec. 18, 2007; 11/958,644, filed Dec. 18, 2007; and 11/958,968, filed Dec. 18, 2007, each of which is incorporated herein by this reference in its entirety.

### FIELD

The invention relates generally to removal, using rare earth metals, of target materials and particularly to removal and stabilization, using rare earth metals, of arsenic.

### BACKGROUND

Harmful metals, such as arsenic, oxyanions of heavy metals, and their radioactive isotopes, naturally occur in a variety of combined forms in the earth. Their presence in natural waters may originate, for example, from geochemical reactions, industrial waste discharges (including those generated by nuclear, oil, and/or coal fired power plants), or agricultural, industrial, and/or home uses of pesticides, herbicides, insecticides, and rodenticides, and other sources. Because the presence of high levels of certain harmful metals, particularly arsenic, may have carcinogenic and other deleterious effects on living organisms, the U.S. Environmental Protection Agency (“EPA”) and the World Health Organization have set the maximum contaminant level (“MCL”) for various harmful metals in drinking water. Harmful metal concentrations in wastewaters, ground waters, surface waters, subterranean waters, and geothermal waters frequently exceed this level. Thus, the current MCL and any future decreases create the need for new techniques to economically and effectively remove arsenic from drinking, well, and industrial waters.

Many of the harmful metals have multiple oxidation states, which can complicate their removal. For example, under normal conditions, arsenic is found dissolved in aqueous or aquatic systems in the +3 and +5 oxidation states, usually in the form of arsenite (AsO₂⁻¹) and arsenate (AsO₄⁻³). The removal of arsenic by adsorption or precipitation technologies requires the arsenic to be in the arsenate form. Arsenite, in which the arsenic exists in the +3 oxidation state, is only partially removed by adsorption and precipitation technologies because the predominate form of arsenite is arsenious acid (HAsO₂). Arsenious acid is a weak acid and maintains a neutral charge (that is, contains minimal, if any, arsenite (AsO₂⁻¹)) at a pH between pH 5 and pH 8 where adsorption takes place most effectively.

Various other technologies have been used to remove harmful metals from aqueous systems. Examples of such technologies include adsorption on high surface area materials, such as alumina and activated carbon, ion exchange with anion exchange resins, co-precipitation optionally using flocculants, and electrodialysis. Most technologies for harmful metal removal are hindered by the difficulty of removing a number of these metals.

Harmful metal removal may be further complicated by co-occurrence with valuable metals. In many industrial processes, contaminated process solids and solutions contain not only harmful metals, such as arsenic, but also valuable metals, such as copper, nickel, cobalt, and/or precious metals. Arsenic is often dissolved selectively from the solid wastes and isolated from streams using a co-precipitation process. This process uses iron reagents to precipitate arsenic as ferric arsenate. This precipitation method requires a series of pH adjustments to form and, in many applications, produces an excessively large volume of, the ferric arsenate precipitate.

Precipitation using rare earth metals is a newly invented technology that has shown promise removing harmful and/or valuable metals from contaminated waste streams. Cerium, in particular, has been used to remove oxyanions of various harmful metals, such as arsenic, antimony, molybdenum, tungsten, vanadium, and uranium.

There is a need for a process to remove harmful and/or valuable metals effectively from solids and/or liquid streams.

### SUMMARY

These and other needs are addressed by the various embodiments and configurations of the present invention. This disclosure relates generally to target material removal from fluids and stabilization of the removed target material.

In one embodiment, a process is provided that includes the steps of:

(a) contacting a process stream (which may be a liquid, gas, slurry, and the like) comprising a target material other than arsenic with a soluble fixing agent, the soluble fixing agent comprising a rare earth, to form an insoluble target material-containing composition comprising the target material and the rare earth; and

(b) removing the insoluble target material-containing composition from the process stream to form a purified process stream.

The insoluble target material-containing composition is typically in the form of precipitate that can be removed as a solid. Preferably, the insoluble target material-containing composition has at least about 0.01 wt. %, even more preferably at least about 0.1 wt. %, and even more preferably ranges from about 5 to about 50 wt. % of the target material. The target material is commonly in the form of an oxygen-containing anion with an oxyanion being illustrative. The soluble fixing agent, or precipitant, can be supported by a suitable carrier or be unsupported. The ability to form the insoluble target material-containing composition in the form of a solid comprising a relatively high concentration of the target material can greatly reduce the volume of the insoluble target material-containing composition requiring disposal, thereby reducing disposal costs.

In another embodiment, a process is provided that includes the steps:

(a) providing an arsenic and a valuable metal-containing solid material;

(b) contacting the solid material with a leaching agent to form a leach stream comprising dissolved arsenic and an arsenic depleted solid, the dissolved arsenic comprising most of the arsenic contained in the solid material and the arsenic depleted solid comprising most of the valuable product contained in the solid material;

(c) contacting the leach stream with a soluble fixing agent to form a target material-containing composition comprising most of the arsenic in the leach stream and the soluble fixing agent; and

(d) removing most of the target material-containing composition from the leach stream, wherein the soluble fixing agent comprises a rare earth.

The fixing agent can be in any suitable form, such as a solid, a coating, a particle, a nano-particle, a sub-micron particle, a dissolved rare earth species, and/or powder. The rare earth can be in the form of a solid, or the solid may be supported by a polymeric binder interconnecting particles of the rare earth-containing compound. The coating can be on any suitable carrier. In one application the fixing agent is a lanthanoid, particularly cerium. The cerium is typically in the form of a cerium (IV) oxide or a dissolved cerium species, which, for example, can be a cerium (III) and/or (IV) salt solution.

The valuable product can be any metal or metalloid, with a transition metal, aluminum, tin, and lead being typical and titanium, chromium, manganese, iron, cobalt, nickel, copper, zinc, molybdenum, a platinum group metal, a precious metal, and mixtures thereof being even more typical.

In another embodiment, a solid-phase composition is provided that includes:

(a) a target material;

(b) oxygen;

(c) water; and

(d) a rare earth.

The lattice structure of the crystalline phase is believed to belong to a trigonal space group.

In the case of arsenic as the target material, the chemical formula of the composition is believed to be:

REAsO₄.(H₂O)_{X}, where 0<X≦10 and “RE” refers to a rare earth element.

The composition is substantially crystalline, with the arsenic, oxygen, rare earth element, and water of hydration forming a crystal lattice.

In another embodiment, a method includes the steps of:

(a) providing a target material-containing stream;

(b) contacting the target material-containing stream with one or both of the following:
(i) a rare earth salt additive, the rare earth salt additive comprising a rare earth in the +3 oxidation state and a non-rare earth metal in the +3 oxidation state; and
(ii) a non-rare earth salt additive, the non-rare earth salt additive comprising a non-rare earth metal in the +3 oxidation state and being substantially free of a rare earth; and

(c) forming a precipitate between the target material and at least one of the rare earth and non-rare earth salt additives.

The non-rare earth metal can be any non-rare earth metal in the +3 oxidation state, with transition metals, boron, aluminum, gallium, indium, thallium, and bismuth being preferred, and the transition metals and aluminum being particularly preferred. Preferred transition metals include the elements having atomic numbers 22-29, 40-45, 47, 72-77, and 79.

The first salt additive is, in one formulation, a bimetallic, lanthanide-based salt solution. In a preferred formulation, the first salt additive includes cerium in the +3 oxidation state and aluminum in the +3 oxidation state.

The second salt additive, in a preferred formulation, contains aluminum in the +3 oxidation state. The first and second salt additives can provide significant reductions in the amount of rare earths required to remove selected target materials, particularly arsenic.

In another embodiment, a process is provided that includes the steps of:

(a) providing a feed stream comprising a target material;

(b) contacting the feed stream with an insoluble fixing agent to form a target material-loaded insoluble fixing agent, the insoluble fixing agent comprising at least one of yttrium, scandium, and a lanthanoid, and the target material-loaded insoluble fixing agent comprising most of the target material in the feed stream, whereby the target material, in the target material-loaded insoluble fixing agent, forms a composition with the insoluble fixing agent;

(c) contacting the target material-loaded insoluble fixing agent with a stripping solution to dissolve, solubilize, or otherwise displace most of the target material in the target material-loaded insoluble fixing agent to form a loaded stripping solution and barren insoluble fixing agent; and

(d) removing at least most of the dissolved target material from the loaded stripping solution.

In one process configuration, first and second fixing agents are used. In a first step, the feed comprises a target material-bearing aqueous solution, having a first concentration of target material. The target-bearing aqueous solution is contacted with an insoluble first fixing agent, such as an adsorbent or absorbent, to produce a target material-bearing first fixing agent. The first step removes most, if not all, of the target material from the target material-bearing aqueous solution. In a second step, the target material-bearing first fixing agent is contacted with an alkaline stripping solution (“release agent”) to produce an intermediate target material-rich solution having a second concentration of the target material. The second concentration of target material may exceed the first concentration of target material. The alkaline stripping solution can be or include, for example, the leaching agent discussed above. Commonly, the second concentration of target material is a concentration about equal to the solubility limit of the target material (at the process conditions of the second step). More commonly the second concentration of the target material is between about 0.1 and about 2,500 g/L, even more commonly between about 0.1 and about 1,000 g/L, and even more commonly between about 0.25 g/L and about 500 g/L. Finally, a soluble or dissolved second fixing agent is contacted with the intermediate target material-rich solution in an amount sufficient to precipitate most, if not all, of the target material as a target material-bearing solid. The target material-bearing solid may be separated from the intermediate solution by any suitable solid/liquid separation technique to produce a separated solid for disposal and a stripping solution for recycle to the second step.

The insoluble first fixing agent is commonly a particulate solid. The first fixing agent preferably is an insoluble rare earth metal compound, preferably an insoluble rare earth oxide comprising an insoluble rare earth compound, such as hydrous or anhydrous rare earth oxides, fluorides, carbonates, fluorocarbonates, silicates, and the like. A particularly preferred first fixing agent is CeO₂. The first fixing agent is particularly effective in removing arsenic having an oxidation state of +3 or +5.

The soluble second fixing agent typically has an oxidation state lower than the oxidation state of the first fixing agent. Preferably, the oxidation state of the second fixing agent is one of +3 or +4. The soluble fixing agent preferably is a soluble rare earth metal compound and more preferably includes salts comprising rare earth compounds, such as bromides, nitrates, phosphites, chlorides, chlorites, chlorates, nitrates, and the like. More preferably, the soluble fixing agent is a rare earth (III) chloride.

In some embodiments, the target material will be present in a reduced oxidation state and this condition might be undesirable. In such cases, an oxidant may be contacted with the solution to increase the target material oxidation state. Using arsenic as an example, the presence of arsenite might favor the use of an oxidant before the fixing agent is applied.

The intermediate solution can include a residual valuable product. The valuable product is commonly any metal of interest, more commonly includes one or more of the transition metals and even more commonly includes a metal selected from the group of metals consisting of copper, nickel, cobalt, lead, precious metals, and mixtures thereof. All or a portion of the residual valuable product may be recovered from the intermediate solution.

In yet another embodiment, a method is provided that includes the steps of:

(a) receiving a target material-containing stream, the target material-containing stream comprising an interferor, the interferor adversely impacting (e.g., impairing the level, extent, and/or degree of) rare earth precipitation of the target material;

(b) removing at least most of the interferor from the target material-containing stream to form a treated stream comprising at least most of the target material; and

(c) thereafter contacting the treated stream with a rare earth fixing agent to precipitate most of the target material from the treated solution.

It has been discovered that interferors, particularly phosphates, fluorides, carbonates, silicates, and vanadate can readily form compositions with or otherwise impede target material removal by the rare earth fixing agent, thereby consuming unnecessarily the fixing agent when it is desired to remove target materials, such as arsenic. Removing the competing or otherwise obstructing oxyanion interferors prior to fixing agent contact with the target material can reduce fixing agent consumption.

In a further embodiment, a method is provided that includes the steps:

(a) providing a target material-containing stream comprising a dissolved target material and dissolved valuable product, the target material being in the form of an oxyanion and the valuable product being at least one of a transition metal, aluminum, tin, and lead and in a form other than an oxyanion;

(b) contacting the target material-containing stream with a rare earth fixing agent to precipitate at least most of the dissolved target material as a target material-containing precipitate while leaving at least most of the valuable product dissolved in a treated stream; and

(c) separating at least most of the target material-containing precipitate from the treated stream.

The present invention can include a number of advantages depending on the particular configuration. The process of the present invention can remove variable amounts of target materials as needed to comply with application and process requirements. For example, the target material removal process can remove high concentrations of target materials to produce a treated solution having no more than about 500 ppm, in some cases no more than about 100 ppm, in other cases no more than about 50 ppm, in still other cases no more than about 20 ppb, and in still other cases no more than about 1 ppb target material. The insoluble rare earth/target material product can be qualified as non-hazardous waste. The target material removal process can be relatively insensitive to pH. The disclosed process can effectively fix target materials, particularly arsenic, from solutions over a wide range of pH levels, as well as at extremely high and low pH values. In contrast to many conventional target material removal technologies, this capability can eliminate the need to alter and/or maintain the pH of the solution within a narrow range when removing the target material. Moreover, where the aqueous solution is produced from the remediation of an arsenic-bearing material, it adds flexibility because the selection of materials and processes for leaching arsenic from an arsenic-bearing material can be made without significant concern for the pH of the resulting arsenic-containing solution. Further still, elimination of the need to adjust and maintain pH while fixing arsenic from an arsenic-containing solution can provide significant cost advantages. The target material removal process can also be relatively insensitive to target material concentration. The process can remove relatively low and high levels of target materials, particularly arsenic, from aqueous streams. The process can be a robust, versatile process.

These and other advantages will be apparent from the disclosure of the invention(s) contained herein.

As used herein, the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

As used herein, “absorption” refers to the penetration of one substance into the inner structure of another, as distinguished from adsorption.

As used herein, “adsorption” refers to the adherence of atoms, ions, molecules, polyatomic ions, or other substances of a gas or liquid to the surface of another substance, called the adsorbent. The attractive force for adsorption can be, for example, ionic forces such as covalent, or electrostatic forces, such as van der Waals and/or London's forces.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means. A alone, B alone, C alone, A and B together, A and C together, B and C together, or A, B and C together.

As used herein, a “composition” refers to one or more chemical units composed of one or more atoms, such as a molecule, polyatomic ion, chemical compound, coordination complex, coordination compound, and the like. As will be appreciated, a composition can be held together by various types of bonds and/or forces, such as covalent bonds, metallic bonds, coordination bonds, ionic bonds, hydrogen bonds, electrostatic forces (e.g., van der Waal's forces and London's forces), and the like.

As used herein, “insoluble” refers to materials that are intended to be and/or remain as solids in water and are able to be retained in a device, such as a column, or be readily recovered from a batch reaction using physical means, such as filtration. Insoluble materials should be capable of prolonged exposure to water, over weeks or months, with little (<5%) loss of mass.

As used herein, “oxyanion” or oxoanion is a chemical compound with the generic formula AₓO_{y}^{z-} (where A represents a chemical element other than oxygen and O represents an oxygen atom). In target material-containing oxyanions, “A” represents metal, metalloid, and/or Se (which is a non-metal), atoms. Examples for metal-based oxyanions include chromate, tungstate, molybdate, aluminates, zirconate, etc. Examples of metalloid-based oxyanions include arsenate, arsenite, antimonate, germanate, silicate, etc.

As used herein, “particle” refers to a solid or microencapsulated liquid having a size that ranges from less than one micron to greater than 100 microns, with no limitation in shape.

As used herein, “precipitation” refers not only to the removal of target material-containing ions in the form of insoluble species but also to the immobilization of contaminant-containing ions on or in insoluble particles. For example, “precipitation” includes processes, such as adsorption and absorption.

As used herein, “rare earth” refers to one or more of yttrium, scandium, lanthanum, cerium, praseodymium, neodymium, samarium, europium, gadolinium, terbium, dysprosium, holmium erbium, thulium, ytterbium, and lutetium. As will be appreciated, lanthanum, cerium, praseodymium, neodymium, samarium, europium, gadolinium, terbium, dysprosium, holmium erbium, thulium, ytterbium, and lutetium are known as lanthanoids.

As used herein, “soluble” refers to materials that readily dissolve in water. For purposes of this invention, it is anticipated that the dissolution of a soluble compound would necessarily occur on a time scale of minutes rather than days. For the compound to be considered to be soluble, it is necessary that it has a significantly high solubility product such that upwards of 5 g/L of the compound will be stable in solution.

As used herein, “sorb” refers to adsorption and/or absorption.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the present invention(s). These drawings, together with the description, explain the principles of the invention(s). The drawings simply illustrate preferred and alternative examples of how the invention(s) can be made and used and are not to be construed as limiting the invention(s) to only the illustrated and described examples.

Further features and advantages will become apparent from the following, more detailed, description of the various embodiments of the invention(s), as illustrated by the drawings referenced below.

FIGS. 1A and B depict a process flow chart according to a first embodiment;

FIG. 2 depicts a process flow chart according to a second embodiment;

FIG. 3 is a plot of loading capacity (mg/g) (vertical axis) versus arsenic concentration (g/L) (horizontal axis);

FIG. 4 is a plot of final arsenic concentration (mg/L) (vertical axis) versus molar ratio of cerium:arsenic (horizontal axis);

FIG. 5 is a plot of final arsenic concentration (mg/L) (vertical axis) versus molar ratio of cerium to arsenic (horizontal axis);

FIG. 6 is a series of XRD patterns for precipitates formed upon addition of Ce (III) or Ce (IV) solutions to sulfide-arsenite solutions and sulfate-arsenate solutions;

FIG. 7 is a plot of arsenic sequestered (micromoles) (vertical axis) and cerium added (micromoles) (horizontal axis);

FIG. 8 is a series of XRD patterns exhibiting the structural differences between gasparite (CeAsO₄) and the novel trigonal phase CeAsO₄.(H₂O)_{X};

FIG. 9 is a plot of residual arsenic concentration (mg/L) (vertical axis) versus molar ratio Ce/As (horizontal axis); and

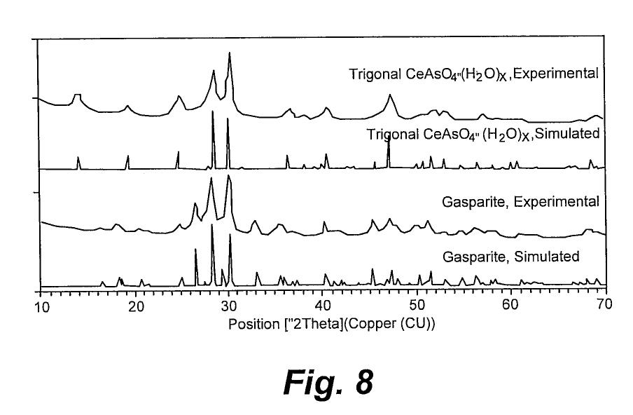

FIG. 10 is a plot of loading capacity (As mg CeO₂ g) (vertical axis) versus molar ratio (Ce/As) (horizontal axis);

FIG. 11 is a plot of residual arsenic concentration (mg/L) (vertical axis) versus molar ratio (horizontal axis); and

FIG. 12 is a series of XRD patterns exhibiting the structural differences among trigonal CeAsO₄.(H₂O)_{X} (experimental), trigonal CeAsO₄.(H₂O)_{X} (simulated), and trigonal BiPO₄.(H₂O)_{0.67} (simulated).

### DETAILED DESCRIPTION

In one aspect, the present invention uses an insoluble or soluble fixing agent or both to remove selected target materials from an aqueous solution. The fixing agent, whether soluble or insoluble, preferably includes a rare earth. Specific examples of such materials that have been described as removing arsenic include lanthanum (III) compounds, soluble lanthanum metal salts, lanthanum oxide, cerium dioxide, and soluble cerium salts.

The particular target materials removed depend on whether the fixing agent is insoluble or soluble in an aqueous process, particularly under standard conditions (e.g., Standard Temperature and Pressure “STP”). While not wishing to be bound by any theory, it is believed, using arsenic and cerium as an example, that insoluble cerium fixing agents remove effectively arsenic, when part of a complex multi-atomic unit having an oxidation state preferably of +3 or higher and even more preferably a oxidation state from +3 to +5, while soluble cerium fixing agents remove effectively arsenic, when part of a complex multi-atomic unit, having an oxidation state of +5. “Target materials”, as used herein, preferably includes not only arsenic but also elements having an atomic number selected from the group of consisting of atomic numbers 5, 9, 13, 14, 22 to 25, 31, 32, 33, 34, 35, 40 to 42, 44, 45, 49 to 53, 72 to 75, 77, 78, 80, 81, 82, 83, 85, 92, 94, 95, and 96 and even more preferably from the group consisting of atomic numbers 5, 13, 14, 22 to 25, 31, 32, 33, 34, 40 to 42, 44, 45, 49 to 52, 72 to 75, 77, 78, 80, 81, 82, 83, 92, 94, 95, and 96. These atomic numbers include the elements of arsenic, aluminum, astatine, bromine, boron, fluorine, iodine, silicon, titanium, vanadium, chromium, manganese, gallium, thallium, germanium, selenium, mercury, zirconium, niobium, molybdenum, ruthenium, rhodium, indium, tin, antimony, tellurium, hafnium, tantalum, tungsten, rhenium, iridium, platinum, lead, uranium, plutonium, americium, curium, and bismuth. Uranium with an atomic number of 92 is an example of a target material having radioactive isotope. Examples of target materials amenable to removal and stabilization by the insoluble fixing agent include, without limitation, target materials in the form of complex anions, such as metal, metalloid, and selenium oxyanions.

In one configuration, the fixing agent reacts with an aqueous solution comprising one or more target material-containing oxyanions to form a purified aqueous stream. The fixing agent can be soluble or in the aqueous solution under standard conditions (e.g., STP). In some instances, the fixing agent can comprise a mixture of fixing agents, the mixture comprising soluble or insoluble fixing agents. The fixing agent reacts with one or more of the target material-containing oxyanions, oxyanion radioactive isotopes, or other toxic elements in an aqueous feed to form insoluble species with the fixing agent. The insoluble species are immobilized, for example, by precipitation, thereby yielding a treated and substantially purified aqueous stream.

Although the disclosure is discussed primarily with reference to arsenic and arsenic-containing species, such as the arsenate and arsenite oxyanions, it is to be understood that the teachings of this disclosure apply equally to the other arsenic-containing compounds and the non-arsenic elements and compounds listed above.

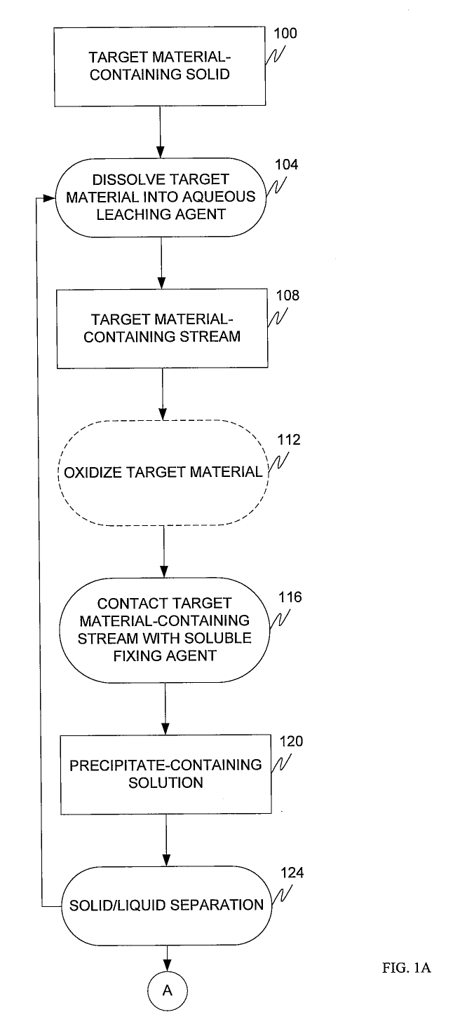

Referring to a first embodiment in FIG. 1A, the target material-containing solid 100 includes one or more target materials and, optionally, a valuable product (which may itself fall within the definition of a target material), such as a transition metal (such as nickel, cobalt, copper, a precious metal (such as, gold, and silver) and/or a platinum group metal (such as, ruthenium, rhodium, palladium, osmium, iridium, and platinum, aluminum, tin, and lead). The target material and valuable product can be present as an element or compound. Examples of the solid 100 include products, byproducts and waste materials from industries such as: mining; metal refining; steel manufacturing; glass manufacturing; metal working processing and/and manufacturing; chemical and petrochemical production, processing and manufacturing; as well as contaminated soil, wastewater sludge, and process stream remediation and the like. Specific examples of target material-bearing solids 100 include ores, mine or mill tailings, concentrates, calcines, slag, and mattes, and spent catalysts.

In one application, the target material-containing solid 100 is derived from an electrolyte, stripping solution, or leach solution containing dissolved nickel in a concentration of from about 5 mg/L to about 1,000 g/L nickel, chlorine in a concentration of from about 5 mg/L to about 1,000 g/L, sulfate in a concentration of from about 5 mg/L to about 5,000 g/L, arsenic (III) in a concentration of from about 1 to about 1,500 mg/L, cobalt in a concentration of from about 5 to about 5,000 mg/L, copper in a concentration of from about 0.1 to about 1,500 mg/L, sodium in a concentration of from about 1 to about 1,500 mg/L, and lead in a concentration of from about 10 mg/L to about 1,500 g/L. The target material-containing solid 100 is derived by contacting, such as by sparging, a reductant, preferably H₂S, through the solution. The resulting target material-containing solid 100 typically includes from about 1 to about 10 wt. As₂S₃, from about 25 to about 75 wt. % CuS, from about 0.1 to about 2.5 wt. % lead, and from about 1 to about 25 wt. % NiS.

In step 104, the target material-containing solid 100 is contacted with an aqueous leaching agent to dissolve the target material (and optionally the valuable product) and form a target material-containing stream 108. The aqueous leaching agent can be any acidic (e.g., pH less than about pH 7) or alkaline (e.g., pH more than about pH 7) leach solution that is capable of dissolving, from the target material-containing solid 100, at least most of the target material. Examples of leaching agents include inorganic salts (e.g., alkali and alkaline earth metal phosphates, chlorides, nitrates, sulfates, and chlorates), inorganic acids (e.g., mineral acids such as sulfuric acid, hydrochloric acid, nitric acid, and phosphoric acid), organic salts (e.g., citrate and acetate), organic acids (e.g., citric acid and acetic acids), and alkaline agents (e.g., hydroxide, cyanide, thiosulfate, and thiourea). Preferably, the leaching agent is a base, such as a carbonate (XCO₃), bicarbonate (XHCO₃), hydroxide (XOH), and other metal oxides and compounds of oxygen, nitrogen, and sulfur with nonbonded electron pairs. X is normally an alkali or alkaline earth metal. More preferably, the alkaline solution includes a leaching agent in an amount of less than about 25% by wt, even more preferably less than about 20 wt. %, and even more preferably ranges from about 1 to about 15 wt. %, with about 5 wt. % being preferred. When the target material is arsenic, the aqueous leaching agent selectively dissolves most of the arsenic while leaving most of the valuable product in the solid material. While not wishing to be bound by any theory, it is believed that the caustic leaching agent metastasizes with copper to form soluble arsenic compounds.

When the aqueous leaching agent is a carbonate and is contacted with the target material-containing solid 100 discussed above, the arsenic-containing aqueous leaching agent commonly includes from about 15 to about 25 g/L Na₂CO₃, 1 to about 30 g/L arsenic (III), from about 1 to about 10 g/L sulfur (e.g., as sulfide, sulfate, and/or sulfite), no more than about 5 g/L chlorine, no more than about 10 mg/L nickel, and no more than about 5 mg/L copper. The pH of the resulting solution is typically about pH 9 or higher and even more typically ranges from about pH 9 to about pH 12.

The target material-containing stream 108 is separated from the target material-depleted solid by any well known liquid/solid separation technique. Solid/liquid separation is commonly performed by a number of techniques, including filtering, hydrocycloning, screening, centrifuging and gravity separating techniques, such as by counter current decantation and settling.

The target material-containing stream 108 typically contains a concentration of dissolved or otherwise solubilized target material ranging from about 0.1 g/L up to the solubility limit of the material in the stream under the conditions of the stream. More typically, the target material-containing stream concentration ranges from about 0.1 g/L to about 1,000 g/L, even more typically the target material concentration ranges from about 0.1 to about 500 g/L, and even more typically the target material concentration ranges from about 0.1 g/L to about 100 g/L.

Optional step 112 adjusts the charge of most and even more preferably of about 75% or more of the target material or a composition incorporating the target material to a selected charge. For example, when the target material is arsenic the preferred oxidation state may be +5 because the soluble fixing agent may not form a precipitate with the arsenic at other arsenic oxidation states, specifically −3 (arsenides) and +3 (arsenites). The oxidation state can be adjusted by any suitable oxidation and/or reduction technique and/or using any suitable oxidant and/or reductant. A non-limiting example of a preferred oxidant is a molecular oxygen-containing gas. The molecular oxygen-containing gas is normally sparged through the target material-containing stream.

Although not shown, the concentration of the target material in the target material-containing stream may be increased by suitable techniques, such as through water removal. Water may be removed, for example, by evaporation, distillation, and/or filtration techniques (such as, membrane filtration). Other techniques include precipitation and redissolution, absorption or adsorption followed by stripping, ion exchange followed by stripping, and the like of the target material.

In one application, most of the interferors (which interfere with removal of the target material), particularly fluorides, phosphates, carbonates, silicates, and vanadium oxides, are removed from the target material-containing stream by suitable techniques, such as ion exchange, membrane filtration, precipitation, a complexing agent, and the like. Interferors can compete with other target materials, particularly arsenic, for available fixing agents, thereby increasing fixing agent consumption and/or lowering levels of target material removal. In this application, the concentration of interferors is maintained preferably at a concentration of no more than about 300 ppm/interferor species and even more preferably no more than about 10 ppm/interferor species.

In step 116, the target material-containing stream 100 is contacted with a soluble fixing agent to form a precipitate-containing solution 120 containing a target metal-containing precipitate 128. Preferably, most and even more preferably 75% or more of the target material or a composition incorporating the target material forms, with the soluble fixing agent, the target material-containing precipitate 128. The soluble fixing agent is preferably one or more of scandium, yttrium, and a lanthanoid and is in a form that is soluble in water and/or the aqueous leaching agent. When the soluble fixing agent comprises cerium, it typically has an oxidation state of +4 or less. The fixing agent can be, without limitation, a soluble salt, such as bromides, nitrates, phosphites, chlorides, chlorites, chlorates, and the like of scandium, yttrium, or a lanthanoid, with a chloride of cerium (III) or cerium (IV) being preferred. While not wishing to be bound by any theory, it is believed that soluble forms of cerium (IV) can form nanocrystalline cerium dioxide, which then sorbs target materials or a composition incorporating the target material. The soluble fixing agent is added, commonly as a separate aqueous solution, to the target material-containing stream preferably in an amount to produce an average molar ratio of fixing agent to target material in solution of less than about 8:1 and more preferably ranging from about 0.5:1 to about 5:1.

During step 116, the pH of the target material-containing stream preferably ranges from about pH 4 to about pH 9 and even more preferably from about pH 5.5 to about pH 8. In some instances, a pH adjustment may be required before step 116. The pH, when too high or too low, can cause the soluble fixing agent (discussed below) to precipitate out of solution (e.g., when the pH is too high, the fixing agent can precipitate out of solution as a carbonate or hydroxide and when the pH is too low the fixing agent can precipitate out of solution as a sulfate).

A chelating agent can be added to the soluble fixing agent aqueous solution to increase the solubility of the fixing agent in the aqueous solution. A typical chelating agent is a chemical compound containing at least two nonmetal entities capable of binding to a metal atom and/or ion. While not wishing to be bound by any theory, chelating agents function by making several chemical bonds with metal ions. Exemplary chelating agents include ethylene diamine tetra acetic acid (EDTA), dimercaprol (BAL), dimercaptosuccinic acid (DMSA), 2,3-dimercapto-1-propanesulfonic acid (DMPS), and alpha lipoic acid (ALA), aminophenoxyethane-tetraacetic acid (BAPTA), deferasirox, deferiprone, deferoxamine, diethylene triamine pentaacetic acid (DTPA), dimercapto-propane sulfonate (DMPS), dimercaptosuccinic acid (DMSA), ethylenediamine tetraacetic acid (calcium disodium versante) (CaNa₂-EDTA), ethylene glycol tetraacetic acid (EGTA), D-penicillamine, methanesulfonic acid, methanephosphonic acid, and mixtures thereof.

The soluble fixing agent can further include an organic or inorganic additive. Preferably, the additive is one or more of a flocculent, coagulant, and thickener, to induce flocculation, settling, and/or formation of the precipitated solids. Examples of such additives include lime, alum, ferric chloride, ferric sulfate, ferrous sulfate, aluminum sulfate, sodium aluminate, polyaluminum chloride, aluminum trichloride, polyelectrolytes, polyacrylamides, polyacrylate, and the like.

In one process configuration, the target material-containing stream includes, in addition to the target material, a dissolved valuable product as a dissociated or dissolved cation. In other words, the dissolved valuable product is not, under the conditions of the stream, in the form of an oxyanion but occurs as a positively charged metal ion. When the soluble fixing agent is added, most of the target material is precipitated while most of the valuable product remains dissolved in the precipitate-containing solution.

In step 124, at least most of the target material-containing precipitate in the resulting slurry is separated from the aqueous leaching agent (which may be recycled to step 104) to form the separated target material-containing precipitate 128 (which includes most of the target material) and treated stream 140 (which includes most of the leaching agent). After step 124, the treated stream 140 typically contains no more than about 500 ppm and even more typically no more than about 50 ppm dissolved target material.

Residual soluble fixing agent dissolved in the aqueous leaching agent can be removed by adding a salt, such as mineral acid salt (e.g., NaCl) or a halide (e.g., an alkali metal or alkaline earth metal fluoride), or selected oxyanion, such as phosphate or sulfate, to the aqueous leaching agent. Alternatively, the soluble rare earth can be oxidized, such as by sparging with oxygen, to a higher oxidation state, optionally followed by pH adjustment to a higher pH, to precipitate the rare earth as an insoluble compound, such as a rare earth oxide. In another technique, the pH of the aqueous leaching agent is increased, preferably to a pH of at least about pH 7 and even more preferably to a pH of at least about pH 10 to precipitate out the residual soluble fixing agent. The removal of excess soluble fixing agent can occur before or after step 124.

The separated target material-containing precipitate 128 is dewatered in step 132 to form the dewatered precipitate 136. Preferably, dewatering is performed for a time and at a temperature sufficient to remove at least about 50% and even more preferably at least about 75% of the water contained within the separated target material-containing precipitate 128. Typically, the separated target material-containing precipitate 128 will be dewatered for a time ranging from about 0.1 to about 24 hours at a temperature ranging from about 0 to about 250° C., with about 8 hours at about 100° C. being even more preferred. The dewatered precipitate 136 is typically a low surface area agglomerate having a high bulk density and low solubility in the aqueous leaching agent. When arsenic (V) is the target material and cerium (III) the soluble fixing agent, it is believed that the precipitate is predominantly gasparite (cerium arsenate). Typically, the dewatered material includes at least about 5 wt. %, even more preferably at least about 10 wt. %, and even more preferably at least about 20 wt. % of the target material. The dewatered precipitates 136 contains preferably at least most and even more preferably at least about 85% of the dissolved target material in the target material-containing stream 108 while the treated stream 140 contains typically no more than about 25% of the dissolved target material in the target material-containing stream 108.

In one configuration, step 116 is performed using a concentrated and acidic rare earth salt solution added at a relatively rapid rate to produce a precipitate that sequesters more arsenic for a given amount of rare earth than is anticipated based on theoretical “best-case” calculations (which is for a rare earth:arsenic molar ratio of 1:1). The preferred rare earth salt concentration in the salt solution is preferably at least about 50 g/L, even more preferably from about 100 to about 400 g/L, and even more preferably from about 300 to about 400 g/L. The preferred pH of the salt solution is no more than about pH 2 and even more preferably no more than about pH 0. A particularly preferred formulation includes a solution of cerium in the +3 and/or +4 oxidation state comprising chloride and/or nitrate counter ions. The resulting precipitate has a low density and is gel-like. The precipitate is substantially free of any crystalline phases of arsenic and rare earth solids. For each mole of rare earth (e.g., cerium (III) or (IV)) in the gel, there is typically more than one mole of arsenic, more typically at least about 1.1 moles of arsenic, and even more typically at least about 1.25 moles of arsenic.

In another configuration, a novel rare earth—target material precipitate is produced. In one process, the rare earth is cerium in the +3 oxidation state, and the target material is arsenic in the +5 oxidation state. Preferably, the cerium is in the form of cerium chloride (CeCl₃) and/or cerium nitrate (Ce(NO₃)₃). The target material-containing stream 108 commonly has an acidic pH and even more commonly a pH of no more than about pH 5. After or concurrently with the addition of the rare earth-containing soluble fixing agent, the pH of the target material-containing stream 108 is raised to a second pH, preferably of at least about pH 6 and even more preferably in the range of about pH 6 to about pH 10. The pH of the target material-containing stream 108 is raised with a strong base, such as an alkali metal hydroxide and group I salt of ammonia, amides, and primary, secondary, tertiary, or quaternary amines, with alkali metal hydroxides being more preferred, and alkali metal hydroxides being even more preferred. The precipitate has a crystal structure different from gasparite. Gasparite (CeAsO₄) has a monoclinic space group with a monazite-type structure. While not wishing to be bound by any theory, it is believed that the crystal structure of the precipitate belongs to a trigonal space group, such as that of an apparently structurally analogous compound, BiPO₄ (H₂O)_{0.67} with space group P3₁21. The PDF card number for trigonal hydrated BiPO₄ is 01-080-0208. It is further believed that the formula of the precipitate is REAsO₄.(H₂O)_{X}, where 0<X≦10 and “RE” is a rare earth element. The water molecules are believed to occupy lattice positions, or are believed to be packed, in the crystalline structure.

In another configuration, the soluble fixing agent is combined with other arsenic removal agents to form a mixed salt additive. For example, the soluble fixing agent(s) are combined with one or more non-rare-earths having a +3 oxidation state, particularly a transition metal or metal from Groups 13 of the Periodic Table of the Elements, with aluminum or iron in the +3 oxidation state being preferred. Preferably, the soluble fixing agent is a rare earth metal in the +3 oxidation state, and the soluble fixing agent and non-rare-earth metal are each in the form of water dissociable salts. For example, a double salt mixture is formed by mixing cerium (III) chloride with aluminum (III) chloride. In another example, the double salt mixture is formed by mixing lanthanum (III) chloride with aluminum (III) chloride. In another example, the double salt mixture is formed by mixing lanthanum (III) chloride with iron (III) chloride. In a preferred formulation, at least one mole of the non-rare-earth is present for each mole of the rare earth soluble fixing agent. In a more preferred formulation, at least 3 moles of the non-rare-earth are present for each mole of the rare earth soluble fixing agent. In an even more preferred formulation, at least one mole of the non-rare-earth having an oxidation state of +3 is present for each mole of the rare earth soluble fixing agent having an oxidation state of +3. In a yet even more preferred formulation, at least 3 moles of the non-rare-earth having an oxidation state of +3 are present for each mole of the rare earth soluble fixing agent having an oxidation state of +3.

The contacting conditions for the mixed salt additive and target material-containing stream 108 depend on the application. The mixed salt additive can have any pH; that is, the mixed salt can have an acidic, neutral, or basic pH. Preferably, the mixed salt additive has a pH less, that is more acidic, than the target material-containing stream 108 pH. More preferably, the mixed salt additive has an acidic pH, particularly when the pH of the target material-containing stream 108 is basic. The mixed salt additive, which is typically a bimetallic lanthanide-based salt solution, is contacted with the target material-containing stream 108 at standard or higher temperature. The pH of the target material-containing stream 108, before and after mixed salt addition, can range from about pH 0 to about pH 14. More preferably, the pH of the mixed solution ranges from about pH 8.5 to about pH 13.5. The mixed salt solution can be contacted with the target material-containing stream over a wide temperature range, preferably from about the freezing point of the stream to about the boiling point of the target material-containing stream.

The contacting of the bimetallic lanthanide-based salt and the target material-containing stream 108 produces a precipitate. When the target material is arsenic, the precipitate is, for example, believed to be arsenoflorencite-(RE) [(RE)Al₃(AsO₄)₂(OH)₆] when the mixed salt additive comprises a rare earth (“RE”) and aluminum (III), and graulichite-(RE) [(RE)Fe₃(AsO₄)₂(OH)₆] when the mixed salt additive comprises a rare earth and iron (III).

The separated liquid phase of the precipitate-containing solution 120 (hereinafter the treated stream 140) retains most, if not all, of the dissolved sulfides, while the target material-containing precipitate 128 contains most, if not all, of the target material, rare earth, and the non-rare-earth(s) contained in the mixed salt additive. As can be seen from the above mineral formulas, the ratio of rare earth to arsenic is at least about 1:2, which represents a significant reduction in rare earth consumption relative to the configurations noted above in which rare earth arsenates, [REAsO₄], are precipitated.

In another configuration, the soluble fixing agent is a non-rare-earth salt additive that does not include, or is substantially free of, rare earth metals. For example, the non-rare-earth is particularly a transition metal or metal from Groups 13 of the Periodic Table of the Elements, with aluminum in the +3 oxidation state being preferred. Preferably, the soluble fixing agent is the form of a non-rare earth (in a +3 oxidation state) salt which substantially dissociates in water under standard conditions (e.g., STP).

The contacting conditions for the mixed salt additive and target material-containing stream 108 are not critical. Although the pH of the salt additive solution can be acidic or basic, the preferred pH is acidic, particularly when the pH of the target material-containing stream 108 is basic. The salt additive solution is contacted with the target material-containing stream 108 at standard (e.g., STP) or higher temperature. The pH of the target material-containing stream 108, before and after salt addition, can range from about pH 0 to about pH 14. More preferably, the pH of the mixed solution ranges from about pH 8.5 to about pH 13.5. The mixed salt solution can be added to the target material-containing stream over a wide temperature range, preferably from about the freezing point to about the boiling point of the target material-containing stream.

A precipitate forms from the contacting of the salt additive solution with the target material-containing stream 108. When the target material is arsenic, the precipitate is believed to be alarsite [AlAsO₄] or mansfieldite [AlAsO₄.H₂O] when the mixed salt additive comprises aluminum (III), and scorodite [FeAsO₄] when the mixed salt additive comprises iron (III).

The separated liquid phase of the precipitate-containing solution 120 (or treated stream 140) retains most, if not all, of the dissolved sulfides while most, if not all, of the target material and non-rare-earth metal in the +3 oxidation state are contained in the target material-containing precipitate 128.

In one process configuration described above, the target material-containing stream includes dissolved valuable product(s) in a form other than as oxyanions. The stream is subjected to steps 112 (optional), 120, 124 and 128 to form a treated solution and an target material-containing precipitate. At least most, if not all, of the dissolved valuable product(s) remain in solution for recovery by any suitable technique. While not wishing to be bound by any theory, it is believed that soluble and insoluble rare earth fixing agents commonly do not remove metal and metalloid dissociated cations from solution. This can permit metal and metalloid oxyanions to be removed selectively from a solution containing both metal and metalloid oxyanions and dissociated cations.

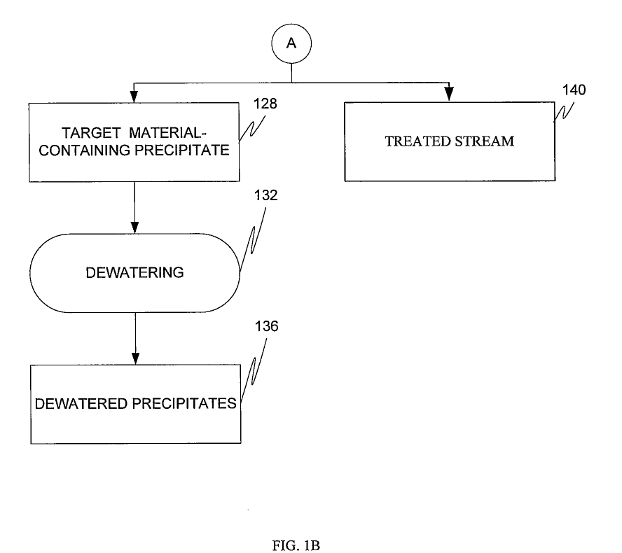

A second embodiment will now be discussed with reference to FIG. 2.

A target material-containing stream 200 is provided. The target material-containing stream 200 can be the stream 108 or any other process stream, byproduct and waste stream from industries such as: mining; metal refining; steel manufacturing; glass manufacturing; metal manufacturing, working and/or processing; chemical and petrochemical production, processing and manufacturing; streams produced from treating and/or remediating a contaminated soil, a wastewater sludge, and the like. Specific examples of target material-bearing streams include pregnant or barren leach solutions and/or other effluent streams, such as contaminated water. While portions of the disclosure herein refer to the removal of arsenic from mining tailings and residues from hydrometallurgical operations, such references are illustrative and should not be construed as limiting. As will be appreciated by one of ordinary skill in the art, the teachings are applicable to other target materials.

The target material concentration in the stream 200 is typically the same as the target material concentration in the target material-containing stream 108. Arsenic, for example, can be present in concentrations of more than about 20 ppb arsenic and even more than 1,000 ppb arsenic. The stream 200 can include other dissolved components, such as sulfides and/or sulfates in concentrations noted elsewhere in this disclosure. The pH of the stream 200 can be acidic, neutral, or basic, depending on the application. The stream 200 can also include dissolved solids with a common total dissolved solid (“TDS”) level being at least about 5 g/L, more commonly at least about 20 g/L, and even more commonly at least about 100 g/L.

In step 204, the stream 200 is contacted with an insoluble fixing agent to form a target material-loaded insoluble fixing agent 212 and a treated stream 208. Preferably most, and even more preferably about 75% or more, of the target material is loaded on the insoluble fixing agent. The target material forms a composition with the insoluble fixing agent. The affinity of the insoluble fixing agent for specific target materials is believed to be a function of pH and/or target material concentration. The insoluble fixing agent is commonly used as a particulate in a fixed or fluidized bed and, in certain configurations, may be desirable for use in a stirred tank reactor. In one configuration, the insoluble fixing agent is contained in one or more columns arranged in series or parallel. In one configuration, the insoluble fixing agent includes a flocculent and/or dispersing agent, such as those discussed above, to maintain a substantially uniform particle distribution in the bed.

For some insoluble fixing agents, step 204 may be preceded by an oxidation step 112 to oxidize the target material for better target material removal efficiency and/or affinity of the target material for the insoluble fixing agent.

The insoluble fixing agent is preferably a rare earth and is in a form that is substantially insoluble in water. The insoluble fixing agent can be, for example, a hydrous or anhydrous rare earth oxide, fluoride, carbonate, fluorocarbonate, or silicate of scandium, yttrium, or a lanthanoid, with an oxide of cerium being preferred and cerium (IV) oxide even more preferred. The insoluble fixing agent is preferably a finely divided solid having an average surface area of between about 25 m²/g and about 500 m²/g, more preferably between about 70 m²/g and about 400 m²/g, and even more preferably between about 90 m²/g and about 300 m²/g.

The insoluble fixing agent can be blended with or include other components, such as ion-exchange materials (e.g., synthetic ion exchange resins), porous carbon such as activated carbon, metal oxides (e.g., alumina, silica, silica-alumina, gamma-alumina, activated alumina, acidified alumina, and titania), metal oxides containing labile metal anions (such as aluminum oxychloride), non-oxide refractories (e.g., titanium nitride, silicon nitride, and silicon carbide), diatomaceous earth, mullite, porous polymeric materials, crystalline aluminosilicates such as zeolites (synthetic or naturally occurring), amorphous silica-alumina, minerals and clays (e.g., bentonite, smectite, kaolin, dolomite, montmorillinite, and their derivatives), ion exchange resins, porous ceramics metal silicate materials and minerals (e.g., one of the phosphate and oxide classes), ferric salts, and fibrous materials (including synthetic (for example, without limitation, polyolefins, polyesters, polyamides, polyacrylates, and combinations thereof) and natural (such as, without limitation, plant-based fibers, animal-based fibers, inorganic-based fibers, cellulosic, cotton, paper, glass and combinations thereof).

The insoluble fixing agent may be derived from precipitation of a rare earth metal salt or from thermal decomposition of, for example, a rare earth metal carbonate or oxalate at a temperature preferably between about 100 to about 700 and even more preferably between about 180 and 350° C. in a furnace in the presence of an oxidant, such as air. Formation of the insoluble fixing agent is further discussed in copending U.S. application Ser. No. 11/932,837, filed Oct. 31, 2007, which is incorporated herein by this reference.

Although the preferred insoluble fixing agent comprises a rare earth compound, other fixing agents may be employed. Any fixing agent, whether solid, liquid, gaseous, or gel, that is effective at fixing the target material in solution through precipitation ion exchange, or some other mechanism may be used. Examples of other fixing agents include at least those set forth above.

In one configuration, the insoluble fixing agent is an aggregated particulate having a mean surface area of at least about 1 m²/g. Depending on the application, higher surface areas may be desired. For example, the aggregated particulates can have a surface area of at least about 5 m²/g; in other cases, more than about 10 m²/g; and, in still other cases, more than about 25 m²/g. Where higher surface areas are desired, the particulates can have a surface area of more than about 70 m²/g; in other cases, more than about 85 m²/g; in still other cases, more than about 115 m²/g; and, in still other cases, more than about 160 m²/g. The aggregated particulates can include a polymer binder, such as thermosetting polymers, thermoplastic polymers, elastomeric polymers, cellulosic polymers, and glasses, to at least one of bind, affix, and/or attract the insoluble fixing agent constituents into particulates having one or more of desired size, structure, density, porosity, and fluid properties.

The insoluble fixing agent can include one or more flow aids, with or without a binder. Flow aids can improve the fluid dynamics of a fluid over and/or through the insoluble fixing agent to prevent separation of slurry components, prevent the settling of fines, and, in some cases, hold the fixing agent and other components in place.

The process 200 operational conditions should be controlled. When arsenic is the target material, for example, the insoluble fixing agent, under proper process conditions, selectively removes at least most of the arsenic while leaving at least most of the valuable product as dissolved (cationic) species in solution. Although the insoluble fixing agent can effectively fix arsenic from solutions over a wide range of pH levels, the pH of the target material-containing stream preferably is no more than about pH 6 and even more preferably ranges from about pH 2 to about pH 5 to adsorb both arsenic (V) and arsenic (III). Arsenic (III) sorbs onto the insoluble fixing agent over a broad pH range while arsenic (V) is preferably sorbed by the insoluble fixing agent at lower pH levels. The aqueous solution may contain dissolved solids, with a total dissolved solid content of at least about 50 g/L being typical.

The treated stream 208 has, relative to the stream 200, a reduced concentration of the target material. Commonly, most, even more commonly about 75% or more, and even more commonly about 95% or more of the target material in the stream 200 is loaded onto the insoluble fixing agent. In one application, the treated stream 208 preferably has no more than about 1,000 ppm, even more preferably no more than about 500 ppm, even more preferably no more than about 50 ppm, and even more preferably no more than about 5 ppm of the target material.

When a pre-selected degree of target material loading occurs, the target material-loaded fixing agent 212 is contacted, in step 216, with a stripping solution, or release agent 238, to unload, or dissolve, preferably most and even more preferably about 95% or more of the agent and form a barren fixing agent 220 (which is recycled to step 204) and a target material-rich stripping solution 224. Any acidic, neutral, or basic stripping solution or release agent may be employed. The desorption process of the rare earth loaded insoluble fixing agent is believed to be a result of a-one or more of: 1) a stronger affinity by the rare earth for the release agent than the sorbed target material or its composition and 2) an upward or downward adjustment of the oxidation state of the rare earth on the surface of the fixing agent 212 and/or of the sorbed target material and/or the sorbed target material-containing oxyanion.

In one application, the stripping solution is alkaline and comprises a strong base, including the strong bases discussed above. While not wishing to be bound by any theory, it is believed that, at high concentrations, hydroxide ions compete with, and displace, oxyanions from the surface of the insoluble fixing agent. In one formulation, the stripping solution includes a caustic compound in an amount preferably ranging from about 1 to about 15 wt. %, even more preferably from about 1 to about 10 wt. %, and even more preferably from about 2.5 to about 7.5 wt. %, with about 5 wt. % being even more preferred.

The preferred pH of the stripping solution 238 is preferably greater (e.g., more basic) than the pH at which the target material was loaded onto the fixing agent 212. The stripping solution 238 pH is preferably at least about pH 10, even more preferably at least about pH 12, and even more preferably at least about pH 14.

In another application, the (first) stripping solution comprises an oxalate or ethanedioate, which, relative to target material-containing oxyanions, is preferentially sorbed, over a broad pH range, by the insoluble fixing agent. In one process variation to desorb oxalate ions, the insoluble fixing agent is contacted with a second stripping solution (not shown) having a preferred pH of at least about pH 9 and even more preferably of at least about pH 11 to desorb oxalate and/or ethanedioate ions in favor of hydroxide ions. A strong base is preferred for the second stripping solution (not shown). Alternatively, the sorbed oxalate and/or ethanedioate anions can be heated to a preferred temperature of at least about 500° C. to thermally decompose the sorbed oxalate and/or ethanedioate ions and remove them from the insoluble fixing agent.

In another application, the (first) stripping solution 238 includes a strongly adsorbing exchange oxyanion, such as phosphate, carbonate, silicate, vanadium oxide, or fluoride, to displace the sorbed target material-containing oxyanion. The first stripping solution has a relatively high concentration of the exchange oxyanion. Desorption of the exchange oxyanion is at done at a different (higher) pH and/or exchange oxyanion concentration than the first stripping solution. For example, desorption can be by a second stripping solution (not shown) which includes a strong base and has a lower concentration of the exchange oxyanion than the oxyanion concentration in the first stripping solution. Alternatively, the exchange oxyanion can be thermally decomposed to regenerate the insoluble fixing agent. Alternatively, the exchange oxyanion can be desorbed by oxidation or reduction of the insoluble fixing agent or exchange oxyanion.

In another application, the stripping solution includes a reductant or reducing agent, such as ferrous ion, lithium aluminum hydride, nascent hydrogen, sodium amalgam, sodium borohydride, stannous ion, sulfite compounds, hydrazine (Wolff-Kishner reduction), zinc-mercury amalgam, diisobutylaluminum hydride, lindlar catalyst, oxalic acid, formic acid, and a carboxylic acid (e.g., a sugar acid, such as ascorbic acid), to reduce the rare earth, sorbed target material, and/or sorbed target material-containing oxyanion. While not wishing to be bound by any theory nor by way of example, surface reduction of the insoluble fixing agent will reduce cerium (IV) to cerium (III), which may interact less strongly with target materials and oxyanions. Following or concurrently with surface reduction of the insoluble fixing agent, the pH is increased to desorb the sorbed target material or its oxyanion.

In another application, the stripping solution includes an oxidant or oxidizing agent, e.g., peroxygen compounds (e.g., peroxide, permanganate, persulfate, etc.), ozone, chlorine, hypochlorite, Fenton's reagent, molecular oxygen, phosphate, sulfur dioxide, and the like, that oxidizes the sorbed target material and/or its oxyanion to a higher oxidation state, e.g., arsenic (III) to arsenic (V), followed by a pH adjustment and a desorption process. Desorption of arsenic (V) from insoluble rare earth compounds, for example, typically occurs at a pH of at least about pH 12 and even more typically at least about pH 14.

Regardless of the precise stripping mechanism, a first concentration of the target material in the target material-containing stream 200 is typically less than a second target material concentration in the target material-rich stripping solution 224. Commonly, the first concentration of the target material is no more than about 75% of the second concentration and even more commonly no more than about 50% of the second concentration. By way of example, a first concentration of the arsenic is between about 0.1 mg/L to about 5 g/L, and the second concentration of arsenic is between about 0.25 g/L and about 7.5 g/L.

In step 228, the target material is removed from the rich stripping solution 224 by a suitable technique to form a target material 232 and a barren stripping solution 236 (which is recycled to step 216). Removal may be effected by any suitable technique including precipitation (such as using a sulfide (for transition metals), an alkaline earth metal carbonate (for fluoride), and a rare earth or iron salt (for arsenic)), adsorption, absorption, electrolysis, cementation, amalgamation, and the like. In one configuration, the target material is precipitated using a soluble rare earth fixing agent as noted above.

In another embodiment, the target material-containing stream 200 is the target material-containing stream 104 (FIG. 1A) and steps 204 and 216 are performed immediately before step 112 or after step 112 and before step 116 to increase the concentration of the target material in the solution prior to step 116. This can provide benefits, such as handling reduced volumes of aqueous solutions in step 116. Additionally, when arsenic is the target material and the solution to be treated contains dissolved metals, performing arsenic removal using an insoluble fixing agent before precipitation by the soluble fixing agent can isolate and selectively remove arsenic from the other metals. As will be appreciated, the soluble fixing agent may not exclusively precipitate arsenic and may depress/remove dissolved metals too.

### EXPERIMENTAL

The following examples are provided to illustrate certain embodiments of the invention and are not to be construed as limitations on the invention, as set forth in the appended claims. All parts and percentages are by weight unless otherwise specified.

### Example 1

A set of tests were conducted to determine a maximum arsenic loading capacity of soluble cerium (III) chloride CeCl₃ in an arsenic-containing stream 108 to reduce the arsenic concentration to less than 50 ppm. As shown by Table 1, the arsenic-containing streams 108 (hereinafter alkaline leach solutions) tested had the following compositions:

TABLE 1

| | Volume | | | | |
|---|---|---|---|---|---|
| Test | of DI | Na₂CO₃ | Na₂SO₄ | Na₂HAsO₄—7H₂O | |
| Number | (mL) | (g) | (g) | (g) | As g/L |
| 1 | 500 | 10 | 8.875 | 1.041 | 0.5 |
| 2 | 500 | 10 | 8.875 | 2.082 | 1 |
| 3 | 500 | 10 | 8.875 | 4.164 | 2 |
| 4 | 500 | 10 | 8.875 | 6.247 | 3 |
| 5 | 500 | 10 | 8.875 | 8.329 | 4 |
| 6 | 500 | 10 | 8.875 | 10.411 | 5 |
| 7 | 500 | 10 | 8.875 | 12.493 | 6 |

The initial pH of the seven alkaline leach solutions was approximately pH 11, the temperatures of the solutions were approximately 70 to 80° C., and the reaction times were approximately 30 minutes.

Seven alkaline leach solutions were made with varying arsenic (V) concentrations, which can be seen in Table 1 above. Each solution contained the same amount of sodium carbonate (20 g/L) and sodium sulfate (17.75 g/L). In a first series of tests, 3.44 mL of cerium chloride (CeCl₃) were added to every isotherm and equates to 0.918 g CeO₂ (approximately 0.05 mole Ce) In a second series of tests, 6.88 mL of cerium chloride was added to every test and equates to 1.836 g CeO₂ (approximately 0.1 mole Ce). Below is the guideline on how each isotherm test was performed.

In a first step, 200 mL of solution were measured out by weight and transferred into a 400 mL Pyrex beaker. The beaker was then placed on hot/stir plate and heated to 70-80° C. while being stirred.

In a second step, 3.44 mL of cerium chloride were measured out, by weight, and poured into the mixing beaker of hot alkaline leach solution. Upon the addition of cerium chloride, a white precipitate formed instantaneously. To ensure that the white precipitate was not cerium carbonate [Ce₂(CO₃)₃.×H₂O], step three was performed.

In the third step, 4.8 mL of concentrated HCl were slowly added dropwise. Fizzing was observed. The solution continued to mix for 30 minutes and was then allowed to cool for 4 hours before sampling.

The results are shown in Table 2:

### Analysis Using ICP-AES

| Approximate | | | | | | |
|---|---|---|---|---|---|---|
| Moles of | | Molar | Final As | Arsenic | Loading | Percent |
| Cerium | Arsenic | Ratio | Concentration | Removed | Capacity | Arsenic |
| Added | (g/L) | (Ce/As) | (mg/L) | (mg) | (mg/g) | Removed |
| 0.005 | 0.5 | 4.2 | 0 | 100 | 104 | 100 |
| | 1.0 | 2.1 | 8 | 199 | 206 | 99 |
| | 2.0 | 1.0 | 159 | 367 | 380 | 92 |
| | 3.0 | 0.7 | 903 | 412 | 426 | 69 |
| | 4.0 | 0.5 | 1884 | 408 | 422 | 51 |
| | 5.0 | 0.4 | 2663 | 445 | 461 | 45 |
| | 6.0 | 0.4 | 3805 | 409 | 422 | 34 |
| 0.01 | 0.5 | 8.3 | 0 | 102 | 53 | 100 |
| | 1.0 | 4.2 | 0 | 201 | 104 | 100 |
| | 2.0 | 2.1 | 55 | 388 | 201 | 97 |
| | 3.0 | 1.4 | 109 | 577 | 299 | 96 |
| | 4.0 | 1.1 | 435 | 709 | 367 | 89 |
| | 5.0 | 0.8 | 1149 | 759 | 392 | 76 |
| | 6.0 | 0.7 | 1861 | 810 | 419 | 67 |

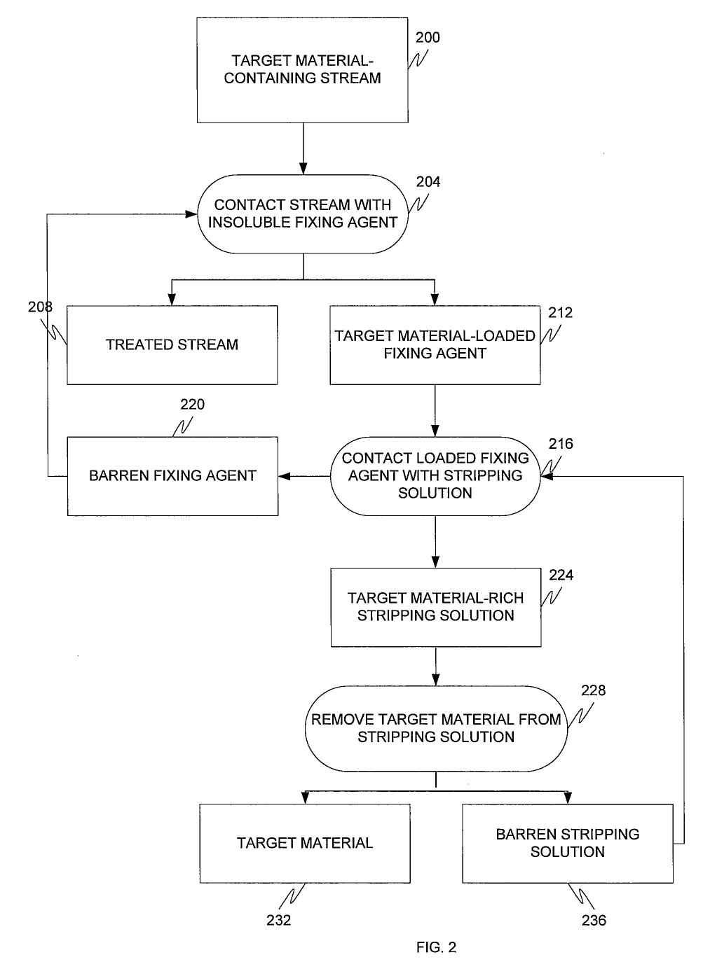

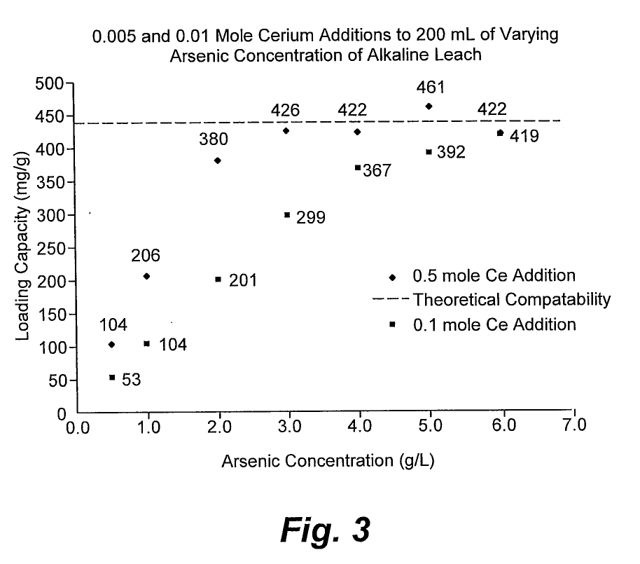

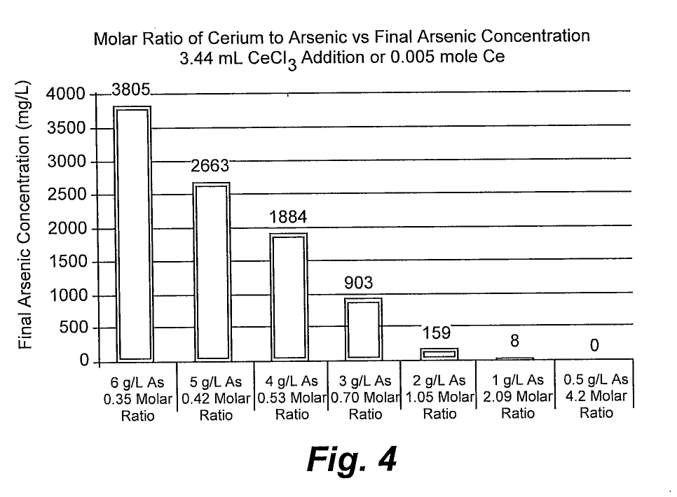

FIG. 3 shows that the loading capacity begins to level off at the theoretical capacity of 436 mg/g if cerium arsenate (CeAsO₄) was formed, leading one to believe it was formed. FIG. 4 displays that the molar ratio of cerium to arsenic required to bring down the arsenic concentration to less than 50 ppm lies somewhere between a 1 molar and 2 molar ratio. However, at a 2 molar ratio a loading capacity of 217 was achieved. FIG. 5 shows very similar results (essentially double the addition of CeCl₃); at a molar ratio between 1 and 2, the dissolved arsenic concentration can be below 50 ppm. This capacity may be improved with a lower molar ratio and tighter pH control.

### Example 2

In another experiment, 40 grams of cerium (IV) dioxide particles were loaded into a 1-inch column giving a bed volume of approximately 50 ml. The cerium dioxide bed had an arsenic-containing process stream [75% As(V), 25% As (III)] flowed through the bed and successfully loaded the media with approximately 44 mg of arsenic per gram CeO₂ or with approximately 1,700 mg of arsenic total added to the column. Following this, the arsenic loaded cerium dioxide bed had the equivalent of six bed volumes of 5% NaOH solution passed through the bed, at a flow rate of 2 mL/min. This solution released approximately 80% of the 44 mg of arsenic per gram CeO₂. Subsequently, the same cerium media was then treated again with the arsenic contaminated process stream [75% As(V), 25% As(III)], loading the media with another 25 mg of arsenic per gram CeO₂ or with another 1,000 mg of arsenic. This experiment demonstrates how to regenerate, and thereby prolong the life of, the insoluble fixing agent and shows that the pH of the arsenic-containing solution can be important to determining the performance of the insoluble fixing agent.

### Example 3

A test was performed to remove residual rare earth fixing agents from an alkaline leach solution.

Fifteen grams of table salt (NaCl) were added to 150 mL of alkaline leach solution that contained residual cerium from cerium nitrate addition. Table 6 shows the beginning (control) and post-salt concentrations in the alkaline leach solution:

TABLE 3

| | As | Ce |
|---|---|---|
| Sample | (ppm) | (ppm) |
| Control | 220 | 4700 |
| Salt Addition | 250 | 270 |

As can be seen from this Table 3, 94% of the residual cerium has been removed.

### Example 4

In this example, the product of cerium and arsenic was shown to contain more arsenic than would be anticipated based upon the stoichiometry of gasparite, the anticipated product of cerium and arsenic. Furthermore, the X-ray diffraction pattern suggests that the product is amorphous or nanocrystalline and is consistent with ceria or, possibly, gasparite. The amorphous or nanocrystalline phase not only permits the recycling of process water after arsenic sequestration but does so with a far greater arsenic removal capacity than is observed from other forms of cerium addition, decreasing treatment costs and limiting environmental hazards.

Eight 50 mL centrifuge tubes were filled with 25 mL each of a fully oxidized solution of arsenate/sulfate/NaOH while another eight 50 mL centrifuge tubes were filled with 25 mL each of a fully reduced solution of arsenite/sulfide/NaOH that had been sparged with molecular oxygen for 2 hours. Both solutions contained 24 g/L arsenic, 25 g/L NaOH, and the equivalent of 80 g/L sulfide. Each sample was then treated with either cerium (IV) nitrate or cerium (III) chloride. The cerium salt solutions were added in doses of 1, 2, 3, or 5 mL. No pH adjustments were made, and no attempt was made to adjust the temperature from ambient 22° C.

Fifteen of sixteen test samples showed the rapid formation of a precipitate that occupied the entire ˜25 mL volume. The reaction between the two concentrated solutions took place almost immediately, filling the entire solution volume with a gel-like precipitate. The sixteenth sample, containing 5 mL of cerium (IV) remained bright yellow until an additional 5 mL of 50% NaOH was added, at which point a purple solid formed.

Solids formed from the reaction of cerium and arsenic were given an hour to settle with little clarification observed. The samples were then centrifuged at 50% speed for 5 minutes. At this point, the total volume of the solution and the volume of settled solids were recorded, and a 5 mL sample was collected for analysis. Since little more than 5 mL of supernatant solution was available (the concentration of arsenic was 24 g/L, meaning that the concentration of cerium was also quite elevated), the samples were filtered using 0.45 micron papers. The four samples with 5 mL of cerium salt added were not filtered. The supernatant solutions were collected and the volume recorded.

The filter cake from the reaction was left over the weekend in plastic weight boats atop a drying oven. Seventy-two hours later, the content of each boat was weighed, and it was determined that the pellets were still very moist (more mass present than was added to the sample as dissolved solids). The semi-dry solids of the samples with 2 mL of cerium salt solution were transferred to a 130° C. drying oven for one hour, then analyzed by XRD.

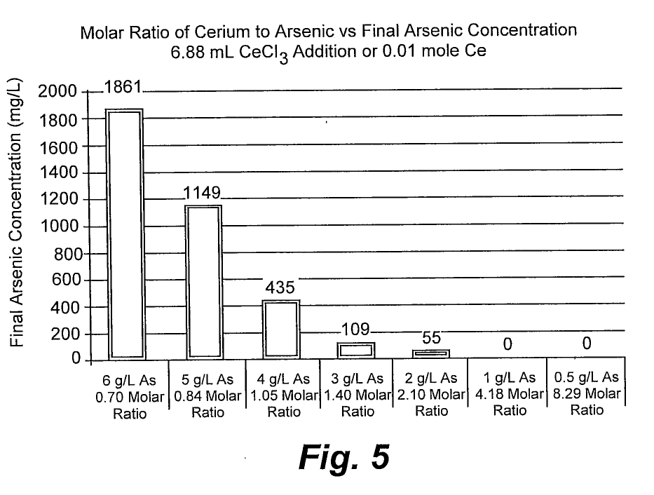

The XRD results are shown in FIG. 6. XRD results are presented for gasparite (the expected product) and the various systems that were present during the experiments, with “ceria” corresponding to cerium dioxide. As can be seen from FIG. 6, the XRD analysis did not detect any crystalline peaks or phases of arsenic and cerium solids in the various systems. The only crystalline material present was identified as either NaCl, NaNO₃ (introduced with the rare earth solutions) or Na₂SO₄ that was present in the samples prepared from Na₂SO₄. However, the broad diffraction peaks at about 29, 49, and 57 degrees 2-Theta could be indicative of very small particles of ceria or, possibly, gasparite.

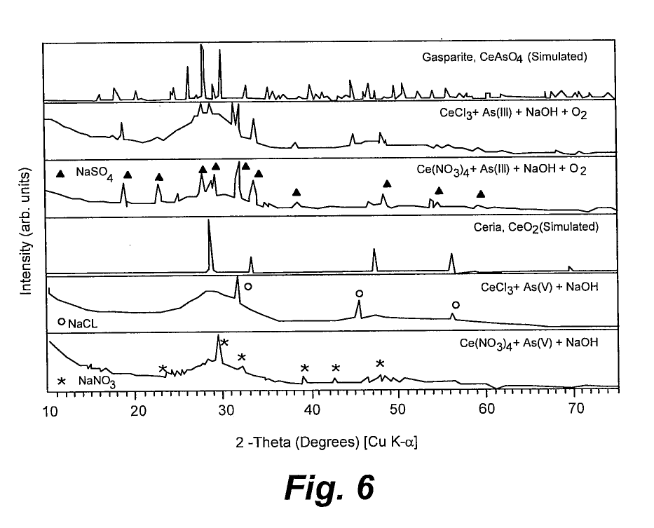

The arsenic content of supernatant solutions was measured using ICP-AES. It was observed that both cerium (IV) and cerium (III) effectively removed arsenic from the system to about the same extent. As can be seen from Table 4 below and FIG. 7, a greater difference in arsenic removal was found between the fully oxidized system, and the system which was fully reduced before molecular oxygen sparging. FIG. 7 shows a plot for arsenic micromoles removed in an “oxidized” system staring with arsenate and a “molecular oxygen sparged” system starting with arsenite, which was subsequently oxidized to arsenate through molecular oxygen sparging.

TABLE 4

| | | | | | Arsenate/sulfate/ | |
|---|---|---|---|---|---|---|
| Arsenite/sulfide/NaOH + O2 | | | | | NaOH | |
| | | | | As | | As |
| | mL | CeO₂ | | capacity | | capacity |
| Cerium Additive | Ce | (g) | As ppm | (mg/g) | As ppm | (mg/g) |
| cerium (III) chloride | 1 | 0.33 | 21200 | 242 | 20000 | 276 |
| | 2 | 0.65 | 18800 | 271 | 8700 | 576 |
| | 3 | 0.98 | 11200 | 324 | 1000 | 596 |
| cerium (IV) nitrate | 1 | 0.26 | 21600 | 265 | 19200 | 429 |
| | 2 | 0.52 | 18800 | 237 | 8000 | 764 |
| | 3 | 0.77 | 13600 | 322 | 3200 | 672 |

| | | | | |
|---|---|---|---|---|
| control | 0 | 0.0 | 25200 | 24400 |

FIG. 7 shows the amount of arsenic consumed by the formation of precipitated solids, plotted as a function of the amount of cerium added. The resultant soluble arsenic concentrations from this experiment can be divided into two groups: samples containing fully oxidized arsenate and sulfate and samples containing arsenite and sulfite that was sparged with molecular oxygen. The oxidation state of the cerium used as the soluble fixing agent had considerably less impact on the efficacy of the process, allowing both Ce(III) and Ce(IV) data to be fit with a single regression line for each test solution. In the case of the fully oxidized solution, arsenic sequestration with the solids increases in an arsenic to cerium molar ratio of 1:3, potentially making a product with a stoichiometry of Ce₃As₄.

### Example 5

A series of experiments were performed, which successfully synthesized a novel Ce—As compound. The experiments embody the precipitation of arsenic, in the As (V) state, from a highly concentrated waste stream of pH less than pH 2 by the addition of a soluble cerium salt in the Ce (III) state followed by a titration with sodium hydroxide (NaOH) solution to a range of between pH 6 and pH 10.

In a first test, a 400 mL solution containing 33.5 mL of a 0.07125 mol/L solution of NaH₂AsO₄ was stirred in a beaker at room temperature. The pH was adjusted to roughly pH 1.5 by the addition of 4.0 mol/L HNO₃, after which 1.05 g of Ce(NO₃)₃.6H₂O was added. No change in color or any precipitate was observed upon the addition of the cerium (III) salt. NaOH (1.0 mol/L) was added to the stirred solution at a dropwise pace to bring the pH to pH 10.1. The pH was held at pH 10.2±0.2 for a period of 1.5 hours under magnetic stir. After the reaction, the solution was removed from the stir plate and allowed to settle undisturbed for 12 to 18 hours. The supernatant was decanted off and saved for ICP-MS analysis of Ce and As. The solids were filtered through a 0.4 μm cellulose membrane and washed thoroughly with 500 to 800 mL of de-ionized water. The solids were air-dried and analyzed by X-ray diffraction.

In a second test, a simulated waste stream solution was prepared with the following components: As (1,200 ppm), F (650 ppm), Fe (120 ppm), S (80 ppm), Si (50 ppm), Ca (35 ppm), Mg (25 ppm), Zn (10 ppm), and less than 10 ppm of Al, K, and Cu. The pH of the solution was titrated down to pH 0.4 with concentrated HCl (12.1 mol/L), and the solution was heated to 70° C. A solution of CeCl₃ (6.3 mL, 1.194 mol/L) was added to the hot solution, and the pH was slowly increased to pH 7.5 by dropwise addition of NaOH (20 wt. %, 6.2 mol/L). The solution was then allowed to age at 70° C. under magnetic stirring for 1.5 hours, holding pH at pH 7.5±0.2. The solution was then removed from the heat and allowed to settle undisturbed for 12 to 18 hours. The supernatant was decanted off and saved for ICP-MS analysis of Ce and As. The precipitated solids were centrifuged and washed twice before being filtered through a 0.4 μm cellulose membrane and washed thoroughly with 500 to 800 mL of de-ionized water. The solids were air-dried and analyzed by X-ray diffraction.

In a third test, solid powders of the novel Ce—As compound were tested for stability in a low-pH leach test. 0.5 g of the novel Ce—As compound were added to 10 mL of an acetic acid solution with a pH of either pH 2.9 or pH 5.0. The container was sealed and rotated for 18±2 hours at 30±2 revolutions per minute at an ambient temperature in the range of 22±5° C. After the required rotation time, the solution was filtered through a 0.2 micron filter and analyzed by ICP-MS for Ce and As which may have been leached from the solid. Less than 1 ppm of As was detected by ICP-MS.

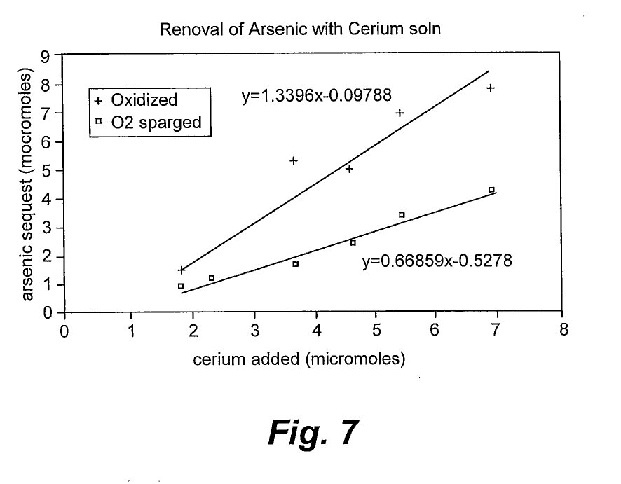

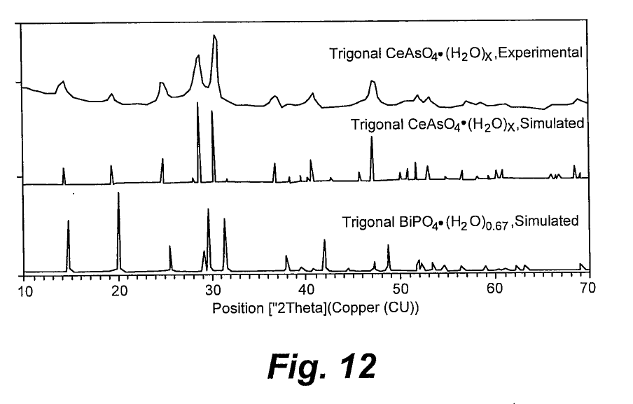

FIG. 8 compares the X-Ray Diffraction (“XRD”) results for the novel Ce—As compound (shown as trigonal CeAsO₄.(H₂O)_{X} (both experimental and simulated) and gasparite (both experimental and simulated). FIG. 12 compares the XRD results for trigonal CeAsO₄.(H₂O)_{X} (both experimental and simulated) and trigonal BiPO₄.(H₂O)_{0.67} (simulated). The XRD results show that the precipitated crystalline compound is structurally different from gasparite (CeAsO₄), which crystallizes in a monoclinic space group with a monazite-type structure, and is quite similar to trigonal BiPO₄.(H₂O)_{0.67}.

Experiments with different oxidation states of Ce and As demonstrate that the novel Ce—As compound requires cerium in the Ce (III) state and arsenic in the As(V) state. pH titration with a strong base, such as sodium hydroxide, seems to be necessary. As pH titration with sodium carbonate produces either gasparite, a known and naturally occurring compound or a combination of gasparite and trigonal CeAsO₄.(H₂O)_{X}. The use of cerium chloride and cerium nitrate both successfully demonstrated the successful synthesis of the novel compound. The presence of other metal species, such as magnesium, aluminum, silicon, calcium, iron, copper, and zinc, have not been shown to inhibit the synthesis of the novel compound. The presence of fluoride will compete with arsenic removal and produce an insoluble CeF₃ precipitate. Solutions containing only arsenic and cerium show that a Ce:As atomic ratio of 1:1 is preferable for forming the novel compound, and solutions containing excess cerium have produced a cerium oxide (CeO₂) precipitate in addition to the novel compound. Additionally, the novel compound appears to be quite stable when challenged with a leach test requiring less than 1 ppm arsenic dissolution in solution of pH 2.9 and pH 5.0.

### Example 6

In a first test, 50 mL of synthetic waste water containing 24 g/L arsenic, 25 g/L sodium hydroxide, and 80 g/L sodium sulfide were added to a flask and heated to 70° C. under magnetic stir. Initial solution pH was found to be pH 12.0. Dropwise addition of 19.6 g of cerium-aluminum chloride solution (83.7 g/L Ce, 54.0 g/L Al, D=1.29 g/L) yielded a flaky, white solid precipitate. Sodium hydroxide solution (NaOH, 20%) was added as needed to maintain a solution pH of pH 10.0 or higher during addition of the bimetallic lanthanide-based salt solution. After complete addition of the bimetallic lanthanide-based salt solution, the solution is aged at 70° C. under magnetic stir for 30 minutes. After cooling, the final solution pH is pH 10.4. The solid precipitate was filtered through a 0.4 μm membrane and dried. ICP-AES analysis of the feed and treated solutions indicates that the arsenic concentration was decreased from 23,800 ppm to 4,300 ppm. This is an 82% removal rate at a capacity of 730 mg arsenic/gram of CeO₂.

In a second test, 30 mL of synthetic waste water containing 24 g/L arsenic, 25 g/L sodium hydroxide, and 80 g/L sodium sulfide were added to a flask at 22° C. under magnetic stir. Initial solution pH was found to be pH 13.0. Dropwise addition of 11.9 g of cerium-aluminum chloride solution (83.7 g/L Ce, 54.0 g/L Al, D=1.29 g/L) yielded a flaky, white solid precipitate. Sodium hydroxide solution (NaOH, 20%) was added as needed to maintain a solution pH of pH 10.0 or higher during addition of the bimetallic lanthanide-based salt solution. After complete addition of the bimetallic lanthanide-based salt solution, the solution is heated to 70° C. under magnetic stir and aged for 60 minutes. After cooling, the final solution pH is pH 11.0. The solid precipitate was centrifuged and washed with water two times, then dried. ICP-AES analysis of the feed and treated solutions indicates that the arsenic concentration was decreased from 23,800 ppm to 2,750 ppm. This is an 89% removal rate at a capacity of 770 mg arsenic/gram of CeO₂.

### Example 7

In a first test, 30 mL of synthetic waste water containing 24 g/L arsenic, 25 g/L sodium hydroxide, and 80 g/L sodium sulfide were added to a flask and heated to 70° C. under magnetic stir. Initial solution pH was found to be pH 12.8. Dropwise addition of 17.3 g of aluminum chloride solution (54.0 g/L Al, D=1.20 g/L) yielded a flaky, white solid precipitate. Sodium hydroxide solution (NaOH, 20%) was added as needed to maintain a solution pH of pH 10.0 or higher during addition of the aluminum chloride solution. After complete addition of the aluminum-based salt solution, the solution is aged at 70° C. under magnetic stir for 30 minutes. After cooling, the final solution pH is pH 10.3. The solid precipitate was centrifuged and washed with water two times, then air dried. ICP-AES analysis of the feed and treated solutions indicates that the arsenic concentration was decreased from 23,800 ppm to 6,830 ppm. This is a 73% removal rate at a capacity of 200 mg arsenic/gram of Al₂O₃.

In a second test, 30 mL of synthetic waste water containing 24 g/L arsenic, 25 g/L sodium hydroxide, and 80 g/L sodium sulfide was added to a flask and heated to 70° C. under magnetic stir. Initial solution pH was found to be pH 12.5. Dropwise addition of 17.3 g of aluminum chloride solution (54.0 g/L Al, D=1.20 g/L) yielded a flaky, white solid precipitate. Sodium hydroxide solution (NaOH, 20%) was added as needed to maintain a solution pH of pH 9.0 or higher during addition of the aluminum salt solution. After complete addition of the aluminum salt solution, the solution is heated to 70° C. under magnetic stir and aged for 30 minutes. After cooling, the final solution pH is pH 9.2. The solid precipitate was centrifuged and washed with water two times, then air dried. ICP-AES analysis of the feed and treated solutions indicates that the arsenic concentration was decreased from 23,800 ppm to 3,120 ppm. This is an 87.5% removal rate at a capacity of 245 mg arsenic/gram of Al₂O₃.

### Example 8

A number of tests were undertaken to evaluate solution phase cerium ion precipitations.

### Test 1:

Solutions containing 250 ppm of Se(IV) or Se(VI) were amended with either Ce(III) chloride or Ce(IV) nitrate at concentrations sufficient to produce a 2:1 mole ratio of Se:Ce. Solids formation was observed within seconds in the reactions between Ce and Se(IV) and also when Ce(IV) was reacted with Se(IV). However, no solids were observed when Ce(III) reacted with Se(VI).

Aliquots of these samples were filtered with 0.45 micron syringe filters and analyzed using ICP-AES. The remaining samples were adjusted to pH 3 when Ce(IV) was added, and to pH 5 when Ce(III) was added. The filtered solutions indicated that Ce(III) did not significantly decrease the concentration of Se(VI). However, Ce(IV) decreased the concentration of soluble Se(VI) from 250 ppm to 60 ppm. Although Ce(IV) did not initially decrease the concentration of Se(IV) at the initial system pH of 1.5, after increasing to pH 3 >99% of the Se was filtered from the sample. Ce(III) decreased the concentration of Se(IV) from 250 ppm to 75 ppm upon addition and adjustment to pH 5.

### Test 2:

Solutions containing 250 ppm of Cr(VI) were amended with a molar equivalent of cerium supplied as either Ce(III) chloride or Ce(IV) nitrate. The addition of Ce(III) to chromate had no immediate visible affect on the solution, however 24 hours later there appeared to be a fine precipitate of dark solids. In contrast, the addition of Ce(IV) led to the immediate formation of a large amount of solids.

As with the previous example, aliquots were filtered, and the pH adjusted to pH 3 for Ce(IV) and pH 5 for Ce(III). The addition of Ce(III) had a negligible impact on Cr solubility, however Ce(IV) removed nearly 90% of the Cr from solution at pH 3.

### Test 3:

Solutions containing 250 ppm of fluoride were amended with cerium in 1:3 molar ratio of cerium:fluoride. Again the cerium was supplied as either Ce(III) chloride or Ce(IV) nitrate. While Ce(IV) immediately formed a solid precipitate with the fluoride, Ce (III) did not produce any visible fluoride solids in the pH range 3-4.5.

### Test 4:

Solutions containing 50 ppm of molybdenum Spex ICP standard, presumably molybdate, were amended with a molar equivalent of Ce(III) chloride. As with previous samples, a solid was observed after the cerium addition and an aliquot was filtered through a 0.45 micron syringe filter for ICP analysis. At pH 3, nearly 30 ppm Mo remained in solution, but as pH was increased to 5, the Mo concentration dropped to 20 ppm, and near pH 7 the Mo concentration was shown to be only 10 ppm.

### Test 5:

Solutions containing 50 ppm of phosphate were amended with a molar equivalent of Ce(III) chloride. The addition caused the immediate precipitation of a solid. The phosphate concentration, as measured by ion chromatography, dropped to 20-25 ppm in the pH range 3-6.

### Example 9

A series of tests were performed to determine if certain halogens, particularly fluoride, interfere with arsenic and other target material removal when using cerium chloride (CeCl₃). This will be determined by doing a comparison study between a stock solution containing fluoride and one without fluoride. For materials used were: CeCl₃ (1.194 M Ce or 205.43 g/L REO) and 400 mL of the stock. The constituents of the stock solution are shown in Tables 5-6:

TABLE 5
Amount of Reagents Added

| | | Amount of |
|---|---|---|
| | Amount of | Reagent Added |
| | Reagent Added | to 3.5 L (g) |
| Compound | to 3.5 L (g) | No Fluoride |
| NaF | 5.13 | 0 |
| AlCl₃•6H₂O | 0.13 | 0.13 |
| CaCl₂•2 H₂O | 0.46 | 0.46 |
| CuSO₄•5H₂O | 0.06 | 0.06 |
| FeSO₄•7H₂O | 2.17 | 2.16 |
| KCl | 0.16 | 0.15 |
| MgCl₂•6H₂O | 0.73 | 0.74 |
| Na₂SiO₃•9H₂O | 1.76 | 1.76 |
| ZnSO₄•7H₂O | 0.17 | 0.17 |
| Na₂HAsO₄•7H₂O | 18.53 | 18.53 |

TABLE 6
Calculated Analyte Concentrations

| | | Theoretical |
|---|---|---|
| | Theoretical | Concentration |
| | Concentration | (mg/L) No |
| Element | (mg/L) | Fluoride |
| Cl | 19032 | 15090 |
| Na | 1664 | 862 |
| K | 24 | 22 |
| Cu | 4 | 4 |
| Fe | 125 | 124 |
| Zn | 11 | 11 |
| As | 1271 | 1271 |
| Mg | 25 | 20 |
| Ca | 36 | 36 |
| Al | 16 | 16 |
| Si | 50 | 50 |
| S | 79 | 79 |
| F | 663 | 0 |

The initial pH of the stock solution was pH ˜0-1. The temperature of the stock solution was elevated to 70° C. The reaction or residence time was approximately 90 minutes.

The procedure for precipitating cerium arsenate with and without the presence of fluorine is as follows:

### Step 1:

Two 3.5 L synthetic stock solutions were prepared, one without fluorine and one with fluorine. Both solutions contained the above listed constituents.

### Step 2:

400 mL of synthetic stock solution was measured gravimetrically (402.41 g) and transferred into a 600 mL Pyrex beaker. The beaker was then placed on hot/stir plate and was heated to 70° C. while being stirred.

### Step 3:

Enough cerium chloride was added to the stock solution to meet a predetermined molar ratio of cerium to arsenic. For example, to achieve a molar ratio of one ceria mole to one mole of arsenic 5.68 mL of cerium chloride was measure gravimetrically (7.17 g) and added to the stirring BHP solution. Upon addition of cerium chloride a yellow/white precipitate formed instantaneously, and the pH dropped due to the normality of the cerium chloride solution being 0.22. The pH was adjusted to approximately 7 using 20% sodium hydroxide.

### Step 4:

Once the cerium chloride was added to the 70° C. BHP solution, it was allowed to react for 90 minutes before being sampled.

### Step 5:

Repeat steps 2-4 for all desired molar ratios for BHP solution containing fluoride and without flouride.

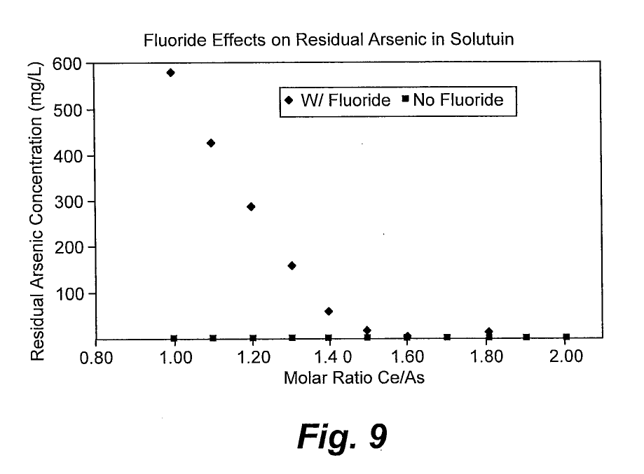

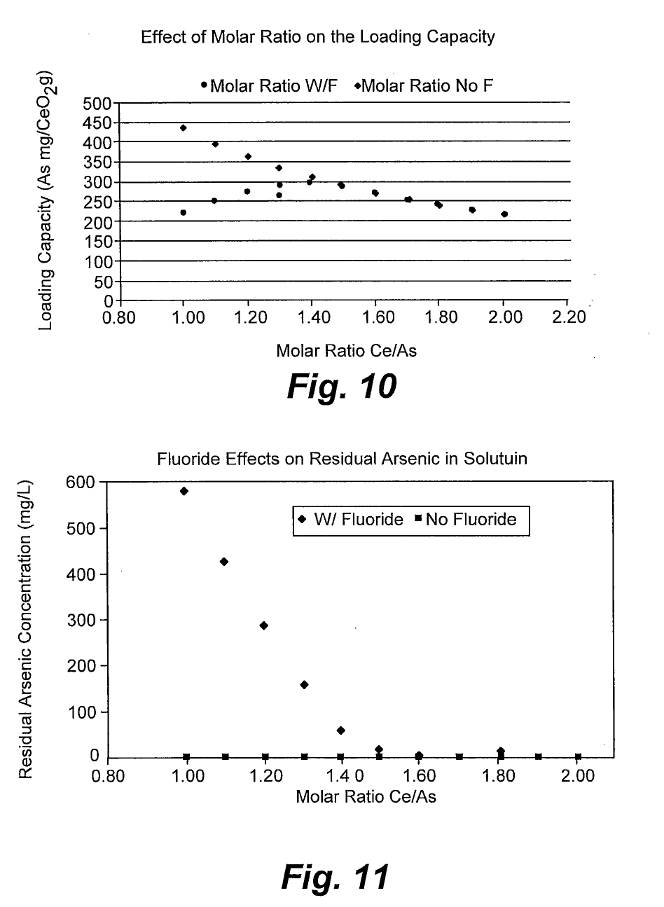

The results are presented in Table 7 and FIGS. 10-11.

TABLE 7
The residual arsenic concentration in supernatant solution
after precipitation with cerium chloride solution

| Molar | Residual As Concentration | Residual As Concentration |
|---|---|---|
| Ratio | w/Fluoride Present (mg/L) | no Fluoride Present (mg/L) |
| 1.00 | 578 | 0 |
| 1.10 | 425 | 0 |
| 1.20 | 286 | 0 |
| 1.30 | 158.2 | 0 |
| 1.40 | 58.1 | 0 |
| 1.50 | 13.68 | 0 |
| 1.60 | 3.162 | 0 |
| 1.71 | 0 | 0 |
| 1.81 | 10.2 | 0 |
| 1.90 | 0 | 0 |
| 2.01 | 0 | 0 |

A comparison of loading capacities for solutions containing or lacking fluoride suggest a benefit in eliminating the fluoride before the addition of cerium. FIG. 10 shows that the loading capacities (which is defined as mg of As per gram of CeO₂) for solutions lacking fluoride are considerably higher at low molar ratios of cerium to arsenic. Steps should be taken to determine a method for the sequestration of fluoride from future stock solutions.

Solutions with a cerium to arsenic molar ratio of approximately 1.4 to 1 or greater had a negligible difference in the loading capacities between solution that contained F⁻ and not having F⁻. This leads one to believe that an extra 40% cerium was needed to sequester the F⁻; then the remaining cerium could react with the arsenic.

These results confirm that the presence of fluoride is interfering with the sequestration of arsenic. The interference comes from the competing reaction forming CeF₃; this reaction has a much more favorable Ksp. A method for pretreatment of fluoride should be considered and developed in order to achieve more efficient use of the cerium.

Accordingly, a fluoride free solution gives better arsenic removal when using lower cerium to arsenic molar ratios, in effect giving higher loading capacities.

### Example 10

40.00 g of cerium was added to 1.00 liter of solution containing either 2.02 grams of As(III) or 1.89 grams of As(V). The suspension was shaken periodically, about 5 times over the course of 24 hours. The suspensions were filtered and the concentration of arsenic in the filtrate was measured. For As(III), the arsenic concentration had dropped to 11 ppm. For As(V), the arsenic concentration was still around 1 g/L, so the pH was adjusted by the addition of 3 mL of conc HCl.

Both suspensions were entirely filtered using a vacuum filter with a 0.45 micron track-etched polycarbonate membrane. The final or residual concentration of arsenic in solution was measured by ICP-AES. The solids were retained quantitatively, and resuspended in 250 mL of DI water for about 15 minutes. The rinse suspensions were filtered as before for arsenic analysis and the filtered solids were transferred to a weigh boat and left on the benchtop for 4 hours.

The filtered solids were weighed and divided into eight portions accounting for the calculated moisture such that each sample was expected to contain 5 g of solids and 3.5 g of moisture (and adsorbed salts). One sample of each arsenic laden solid (As(III) or As(V) was weighed out and transferred to a drying oven for 24 hours, then re-weighed to determine the moisture content.

Arsenic-laden ceria samples were weighed out and transferred to 50 mL centrifuge tubes containing extraction solution (Table 8). The solution (except for H2O2) had a 20 hour contact time, but with only occasional mixing via shaking. Hydrogen peroxide contacted the arsenic-laden solids for two hours and was microwaved to 50 deg C. to accelerate the reaction.

A control sample was prepared wherein the 8.5 g arsenic-laden ceria samples were placed in 45 mL of DI water for the same duration as other extraction tests.

The first extraction test used 45 mL of freshly prepared 1 N NaOH. To increase the chances of forcing off arsenic, a 20% NaOH solution was also examined. To investigate competition reactions, 10% oxalic acid, 0.25 M phosphate, and 1 g/L carbonate were used as extracting solutions. To test a reduction pathway 5 g of arsenic-laden ceria was added to 45 mL of 0.1 M ascorbic acid. Alternatively an oxidation pathway was considered using 2 mL 30% H2O2 added with 30 mL of DI water

After enough time elapsed for the selected desorption reactions to occur, the samples were each centrifuged and the supernatant solution was removed and filtered using 0.45 micron syringe filters. The filtered solutions were analyzed for arsenic content. Litmus paper was used to get an approximation of pH in the filtered solutions.

Because the reactions based upon redox changes did not show a great deal of arsenic release, the still arsenic-laden solids were rinsed with 15 mL of 1 N NaOH and 10 mL of DI water for 1 hour, then re-centrifuged, filtered, and analyzed.

The results of these desorption experiments can be seen in Table 8. In short, it appears that the desorption of As(III) occurs to a minimal extent. In contrast, As(V) adsorption exhibits an acute sensitivity to pH, meaning that As(V) can be desorbed by raising the pH above a value of 11 or 12. As(V) adsorption is also susceptible to competition for surface sites from other strongly adsorbing anions present at elevated concentrations.

Using hydrogen peroxide to convert As(III) to As(V) appeared to be relatively successful, in that a large amount of arsenic was recovered when the pH was raised using NaOH after the treatment with H₂O₂. However, until the NaOH was added, little arsenic desorbed.

While ascorbate did cause a dramatic color change in the loaded media, it was unsuccessful in removing either As(III) or As(V) from the surface of ceria. In contrast, oxalate released a detectable amount of adsorbed As(III) and considerably greater amounts of As(V).

In Experiments with Other Adsorbates:

These experiments examined the adsorption and desorption of a series of non-arsenic anions using methods analogous to those established for the arsenic testing.

Permanganate:

Two experiments were performed. In the first experiment, 40 g of ceria powder were added to 250 mL of 550 ppm KMnO₄ solution. In the second experiment, 20 g of ceria powder were added to 250 mL of 500 ppm KMnO₄ solution and pH was lowered with 1.5 mL of 4 N HCl. Lowering the slurry pH increased the Mn loading on ceria four fold.

In both experiments the ceria was contacted with permanganate for 18 hours, then filtered to retain solids. The filtrate solutions were analyzed for Mn using ICP-AES, and the solids were washed with 250 mL of DI water. The non-pH adjusted solids were washed a second time.

Filtered and washed Mn-contacted solids were weighed and divided into a series of three extraction tests and a control. These tests examined the extent to which manganese could be recovered from the ceria surface when contacted with 1 N NaOH, 10% oxalic acid, or 1 M phosphate, in comparison to the effect of DI water under the same conditions.

The sample of permanganate-loaded ceria powder contacted with water as a control exhibited the release of less than 5% of the Mn. As with arsenate, NaOH effectively promoted desorption of permanganate from the ceria surface. In the case of the second experiment, where pH was lowered, the effect of NaOH was greater than in the first case where the permanganate adsorbed under higher pH conditions.

Phosphate was far more effective at inducing permanganate desorption than it was at inducing arsenate desorption. Phosphate was the most effective desorption promoter we examined with permanganate.

Oxalic acid caused a significant color change in the permanganate solution, indicating that the Mn(VII) was reduced, possibly to Mn(II) or Mn(IV), wherein the formation of MnO or MnO₂ precipitates would prevent the detection of additional Mn that may or may not be removed from the ceria. In the sample that received no pH adjustment, no desorbed Mn was detected. However, in the sample prepared from acidifying the slurry slightly a significant amount of Mn was recovered from the ceria surface.

### Chromate

250 mL of solution was prepared using 0.6 g sodium dichromate, and the solution was contacted with 20 g of cerium powder for 18 hours without pH adjustment. The slurry was filtered and the solids were washed with DI water then divided into 50 mL centrifuge tubes to test the ability of three solutions to extract chromium from the ceria surface.

Ceria capacity for chromate was significant and a loading of >20 mg Cr/g ceria was achieved without any adjustments to pH or system optimization (pH of filtrate was approximately 8). Likewise, the extraction of adsorbed chromate was also readily accomplished. Raising the pH of the slurry containing chromate-laden ceria using 1 N NaOH was the most effective method of desorbing chromium that was tested. Considerably less chromate was desorbed using phosphate and even less was desorbed using oxalic acid. In the control sample, only 5% of the chromate was recovered when the loaded solid was contacted with distilled water.

### Selenite

A liter of selenite solution was prepared using 1 g of Na2SeO2. The pH was lowered using 2 mL of 4 M HCl. 40 g of ceria was added to create a slurry that was provided 18 hours to contact. The slurry was filtered and the Se-loaded ceria was retained, weighed, and divided into 50 mL centrifuge tubes for extraction.

Ceria was loaded with >6 mg/g of Se. While the solids from this reaction were not washed in the preparation stages, the control extraction using DI water exhibited less than 2% selenium release. The extent of selenium adsorption was diminished by adding 1 N NaOH to the loaded ceria, but the effect was not as dramatic as has been seen for other oxyanions. However, by using hydrogen peroxide to oxidize the Se(IV) to Se(VI) the adsorbed selenium was readily released from the ceria surface and recovered. Oxalic acid had no noticeable impact on the extent of selenium adsorption.

### Antimony

The solubility of antimony is rather low and these reactions were limited by the amount of antimony that could be dissolved. In this case, 100 mg of antimony (III) oxide was placed into 1 L of distilled water with 10 mL concentrated HCl, allowed several days to equilibrate, and was filtered through a 0.8 micron polycarbonate membrane to remove undissolved antimony. The liter of antimony solution was contacted with 16 g of ceria powder, which was effective removing antimony from solution, but had too little Sb(III) available to generate a high loading on the surface. In part due to the low surface coverage and strong surface-anion interactions, the extraction tests revealed little Sb recovery. Even the use of hydrogen peroxide, which would be expected to convert Sb(III) to a less readily adsorbed species of Sb(V), did not result in significant amounts of Sb recovery.

Tables 8-11 show the test parameters and results.

TABLE 8
Loading of cerium oxide surface with arsenate and arsenite
for the demonstration of arsenic desorbing technologies.

| | | C | | E | F | | | | | K | L | M |
|---|---|---|---|---|---|---|---|---|---|---|---|---|
| | B | Mass | | Resid | As- | G | H | I | J | Rinse | Rinse | Final |
| | [As] | CeO2 | D | [As] | loading | Wet | Wet | Dry | % | Vol | [As] | [As] |
| A | (g/L) | (g) | pH | (ppm) | (mg/g) | Mass | mass | (g) | Solids | (mL) | (ppm) | (mg/g) |
| As | 2.02 | 40.0 | 9.5 | 0 | 50.5 | 68 | 7.48 | 4.63 | 61.9 | 250 | 0 | 50.5 |
| (III) | | | | | | | | | | | | |
| As | 1.89 | 40.0 | 5 | 149 | 43.5 | 69 | 8.86 | 5.33 | 60.2 | 250 | 163 | 42.5 |
| (V) | | | | | | | | | | | | |

TABLE 9
Loading of cerium oxide surface with arsenate and arsenite
for the demonstration of arsenic desorbing technologies.

| | [As] | | Residual | As-loading | Rinse [As] | Final [As] |
|---|---|---|---|---|---|---|
| | (g/L) | pH | [As] (ppm) | (mg/g) | (ppm) | (mg/g) |
| As (III) | 2.02 | 9.5 | 0 | 50.5 | 0 | 50.5 |
| As (V) | 1.89 | 5 | 149 | 43.5 | 163 | 42.5 |

TABLE 10
Arsenic extraction from the ceria surface
using redox and competition reactions

| Extractant | pH | % As(III) recovered | % As(V) recovered |
|---|---|---|---|
| Water | 7 | 0.0 | 1.7 |
| 1 N NaOH | 13 | 0.2 | 60.5 |
| 20% NaOH | 14 | 2.1 | 51.8 |
| 0.25 PO4 | 8 | 0.4 | 15.0 |
| 10 g/L CO3 | 10 | 2.0 | 7.7 |
| 10% oxalate | 2.5 | 3.0 | 16.5 |
| 30% H2O2 | 6 | 2.0 | 1.5 |
| H202/NaOH | 13 | 25.2 | 31.0 |
| 0.1 M ascorbate | 4 | 0.0 | 0.0 |

TABLE 11
Loading and extraction of other adsorbed elements from the ceria
surface (extraction is shown for each method as the ‘percent
loaded that is recovered)

| | chromate | antimony | selenite | Permanganate | Permanganate |
|---|---|---|---|---|---|
| loading pH | 8 | 2 | 6 | 6 | 11 |
| loading (mg/g) | 20 | 1 | 6 | 4 | 0.7 |
| water (% rec) | 5.1 | <2 | 1.6 | 2.6 | 3.4 |
| 1 N NaOH (% rec) | 83 | <2 | 40.8 | 49.9 | 17.8 |
| 10% oxalic (% rec) | 25.8 | 2.3 | 0.2 | 22.8 | <3 |
| 0.5 M PO4 (% rec) | 60.7 | | | 78.6 | 45.8 |
| 30% H2O2 (% rec) | | 2.3 | 71.9 | | |

### Example 11

Experiments were performed to determine whether cerium (IV) solutions can be used to remove arsenic from storage pond process waters, and accordingly determine the loading capacity of ceria used. In these trials the storage pond solutions will be diluted with DI water, since previous test work has confirmed that this yields a better arsenic removal capability. The soluble cerium (IV) species used are Ceric Sulfate→0.1 M Ce(SO₄)₂ and Ceric Nitrate→4 Ce(NO₃)₄. The pond solution used has an arsenic split between 27% As (III) and 73% As (V), with a of ph 2. Additional components in the pond solution are presented in Table 12:

### Additional Sol'n Components:

| | Analyte | | | | | | | | | | | |
|---|---|---|---|---|---|---|---|---|---|---|---|---|
| | As | B | Ce | Cl | Co | Cu | Fe | Na | Ni | Pb | S | Si |
| | (ppm) | (ppm) | (ppm) | (ppm) | (ppm) | (ppm) | (ppm) | (ppm) | (ppm) | (ppm) | (ppm) | (ppm) |
| Tailings | 2500 | 270 | 4 | 1100 | 140 | 2400 | 130 | 4800 | 19500 | 9 | 15000 | 870 |
| Pond | | | | | | | | | | | | |
| Solution | | | | | | | | | | | | |

### Test 1:

50 mL of storage pond solution was diluted to 350 mL using DI water, a seven fold dilution. The diluted pond solution was heated to a boil and 50 mL of 0.1M Ce(SO₄)₄ was added and mixed for 15 minutes while still at a boil. A yellow/white precipitate formed. This was filtered using a Buchner funnel and 40 Whatman paper. The precipitate was dried at 110° C. overnight, and was weighed at 0.5 g. The filtrate was sampled and filtered using a 0.2μ filter. A full assay was performed on the filtrate using ICP-AES.

### Test 2:

200 mL storage pond solution was diluted to 300 mL using DDI water. The solution was heated to a boil and 8.95 mL of 2.22 Ce(NO₃)₄ was added. The solution boiled for 15 minutes, and a yellow/white precipitate formed. This was filtered using a Buchner funnel and 40 Whatman paper. The precipitate was dried at 110° C. overnight, and was weighed at 2.46 g. The filtrate was sampled and filtered using a 0.2μ filter. A full assay was performed on the filtrate using ICP-AES.

The results are presented in Tables 11-12 below:

TABLE 13

| | Analyte | | | | | | | | | | | |
|---|---|---|---|---|---|---|---|---|---|---|---|---|
| | As | B | Ce | Cl | Co | Cu | Fe | Na | Ni | Pb | S | Si |
| | (ppm) | (ppm) | (ppm) | (ppm) | (ppm) | (ppm) | (ppm) | (ppm) | (ppm) | (ppm) | (ppm) | (ppm) |
| Storage | 2500 | 270 | 4 | 1100 | 140 | 2400 | 130 | 4800 | 19500 | 9 | 15000 | 870 |
| Pond | | | | | | | | | | | | |
| Solution | | | | | | | | | | | | |
| Test 1 | 364 | 273 | 850 | N/A | 133 | 2240 | 126 | 5250 | 14700 | 7 | N/A | 840 |
| 7 FD | | | | | | | | | | | | |
| Test 4 | 639 | 254 | 2900 | N/A | 99 | 2464 | 94 | 4620 | 18480 | 9 | N/A | 601 |
| 1.54 FD | | | | | | | | | | | | |

*Note:
FD denotes “fold dilution” and the dilution has been factored for the reported concentrations

TABLE 14
Calculated Capacities

| | As | | Capacity | Percent | Percent |
|---|---|---|---|---|---|
| | Removed | CeO₂ | (mg As/g | As | Ce still in |
| Test # | (mg) | Used (g) | CeO₂) | Removed | solution |
| 1 | 107 | 0.86 | 124 | 85 | 42 |
| 2 | 372 | 3.44 | 108 | 74 | 32 |

Tables 13 and 14 demonstrate that the cerium (IV) solutions have a preferential affinity for the arsenic. When examining the data closer, it appears that some of the other metals fluctuate in concentrations i.e., nickel. According to the dilution scheme used and the limitations of the instrument, there could be up to 15% error in the reported concentrations, explaining some of the fluctuations. Moving onto to table 12, it shows that tests 1 and 2 removed 85% and 74% of the arsenic respectively.

A number of variations and modifications of the invention can be used. It would be possible to provide for some features of the invention without providing others.

While the various processes are discussed with reference to liquids, it is to be appreciated that the processes can be applies to other fluids, such as gases. Examples of arsenic-containing gases include smelter and roaster off-gases and utility flue gas.

The present invention, in various embodiments, configurations, or aspects, includes components, methods, processes, systems and/or apparatus substantially as depicted and described herein, including various embodiments, configurations, aspects, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method, comprising:
contacting a process stream comprising a target material other than arsenic with a soluble fixing agent, the soluble fixing agent comprising a rare earth, to form an insoluble target material-containing composition comprising the target material and the rare earth; and
removing the insoluble target material-containing composition from the process stream to form a purified process stream.

2. The method of claim 1, wherein the rare earth is selected from the group consisting of at least one of yttrium, scandium, lanthanum, cerium, praseodymium, neodymium, promethium, samarium, europium, gadolinium, terbium, dysprosium, holmium erbium, thulium, ytterbium, and lutetium and wherein the target material is an element having an atomic number selected from the group consisting of 5, 9, 13, 14, 22 to 25, 31, 32, 34, 40 to 42, 44, 45, 49 to 52, 72 to 75, 77, 78, 80, 81, 82, 83, 92, 94, 95, and 96.

3. The method of claim 1, wherein the target material is an element selected from the group consisting of boron, fluorine, aluminum, silicon, titanium, vanadium, chromium, manganese, gallium, germanium, thallium, selenium, mercury, zirconium, niobium, molybdenum, ruthenium, rhodium, indium, tin, antimony, tellurium, hafnium, tantalum, tungsten, rhenium, iridium, platinum, mercury, lead, bismuth, plutonium, americium, curium, uranium and mixtures thereof.

4. The method of claim 1, wherein the soluble fixing agent is in the form of a one of a chloride, bromide, nitrate, phosphite, chlorite, and chlorate and wherein the soluble fixing agent is contained in an salt solution having a pH less than pH 7.

5. A method, comprising:
providing an solid material comprising arsenic and a valuable metal;
contacting the solid material with a leaching agent to form a leach stream comprising at least most of the arsenic from the solid material while at least most of the valuable metal remains in the solid material;
contacting the leach stream with a soluble fixing agent to form an arsenic-containing composition comprising at least most of the arsenic from the leach stream and the soluble fixing agent; and
removing at least most of the arsenic-containing composition from the leach stream, wherein the soluble fixing agent comprises a rare earth.

6. The method of claim 5, wherein the rare earth is at least one of yttrium, scandium, lanthanum, cerium, praseodymium, neodymium, promethium, samarium, europium, gadolinium, terbium, dysprosium, holmium erbium, thulium, ytterbium, and lutetium, wherein the leaching agent comprises one or more of an alkali or alkaline earth metal carbonate, bicarbonate, and hydroxide, wherein the leaching agent has a pH of at least about pH 9, and further comprising:
prior to and/or concurrent with contacting the leach stream with the soluble fixing agent, oxidizing the dissolved arsenic to a selected oxidation state.

7. The method of claim 5, wherein the leach stream comprises fluorine and/or a dissolved oxyanion comprising at least one of phosphorous, carbon, silicon, and vanadium and further comprising:
removing at least most of the dissolved oxyanion and/or fluoride from the leach stream before the leach stream is contacted with the soluble fixing agent.

8. The method of claim 5, wherein the valuable metal is a transition metal, wherein the composition is a solution precipitate that is substantially free of crystalline dissolved arsenic and the undissolved fixing agent, and further comprising:
removing at least most of any residual soluble fixing agent by precipitating the soluble fixing agent from the leach stream.

9. The method of claim 5, wherein the composition is in the form of a precipitate, wherein the leach stream has a ph of no more than about pH 5, and wherein the step of contacting the leach stream with the soluble fixing agent comprises the substep:
after and/or concurrently with contact of the leach stream with the soluble fixing agent, raising, by a strong base, a pH of the leach stream to a pH of at least about pH 6; and
wherein the composition has a crystal structure, the crystal structure belonging to a trigonal space group.

10. The method of claim 5, wherein the leach stream comprises a dissolved valuable metal cation, the valuable metal being one or more of a transition metal, aluminum, tin, and lead, wherein the soluble fixing agent comprises a first salt additive including at least one of yttrium (III), scandium (III), lanthanum (III), cerium (III), praseodymium (III), neodymium (III), promethium (III), samarium (III), europium (III), gadolinium (III), terbium (III), dysprosium (III), holmium erbium (III), thulium (III), ytterbium (III), and lutetium (III) and a second salt additive including a non-rare earth metal in the +3 oxidation state, the non-rare earth metal being one of a transition metal, boron, aluminum, gallium, indium, thallium, and bismuth and wherein, following the removing step, at least most of the dissolved valuable metal remains in the leach stream.

11. A composition, comprising:
a target material;
oxygen;
water; and
a rare earth, wherein the composition is substantially crystalline having a crystalline phase and wherein water of hydration occupies positions in the crystalline lattice.

12. The composition of claim 11, wherein the chemical formula of the crystalline phase of the composition is:
REAsO₄.(H₂O)_{X}, where 0<X≦10 and wherein RE is a rare earth selected from the group consisting of yttrium, scandium, lanthanum, cerium, praseodymium, neodymium, promethium, samarium, europium, gadolinium, terbium, dysprosium, holmium erbium, thulium, ytterbium, lutetium, and combinations thereof.

13. The composition of claim 11, wherein the target material is arsenic and wherein the crystalline structure belongs to a trigonal space group.

14. A method, comprising:
(a) providing an arsenic-containing stream; and
(b) contacting the arsenic-containing stream with at least one of the following:
(i) a rare earth salt additive, the rare earth salt additive comprising a rare earth in the +3 oxidation state and a non-rare earth in the +3 oxidation state; and
(ii) a non-rare earth salt additive, the non-rare earth salt additive comprising a non-rare earth in the +3 oxidation state and being substantially free of a rare earth; and
wherein the non-rare earth has an atomic number selected from the group of atomic numbers consisting of 5, 13, 22-29, 31, 40-45, 47, 49, 72-77, 79, 81, and 83, whereby the at least one of the rare earth and non-rare earth salt additives forms a precipitate with the arsenic.

15. The method of claim 14, wherein the rare earth salt additive is contacted with the arsenic-containing stream.

16. The method of claim 15, wherein at least three moles of the non-rare earth in the +3 oxidation state are present for each mole of the rare earth in the +3 oxidation state and wherein at least two moles of arsenic are present in the precipitate for each mole of rare earth.

17. The method of claim 14, wherein the non-rare earth salt additive is contacted with the arsenic-containing stream.

18. A method, comprising:
providing a feed stream comprising a target material;
contacting the feed stream with an insoluble fixing agent to form a target material-loaded insoluble fixing agent, the insoluble fixing agent comprising a rare earth, and the loaded insoluble fixing agent comprising at least most of the target material in the feed stream, whereby the target material, in the loaded insoluble fixing agent, forms a composition with the insoluble fixing agent;
contacting the loaded insoluble fixing agent with a stripping solution to dissolve at least most of the target material in the stripping solution and form a loaded stripping solution and barren insoluble fixing agent; and
removing at least most of the dissolved target material from the loaded stripping solution.

19. The method of claim 18, wherein the target material comprises an element selected from the group consisting of atomic numbers 5, 13, 14, 22 to 25, 31, 32, 33, 34, 40 to 42, 44, 45, 49 to 52, 72 to 75, 77, 78, 80, 81, 82, 83, 92, 94, 95, and 96, wherein a pH of the feed stream, when in contact with the insoluble fixing agent, is no more than about pH 6 and wherein the stripping solution has a pH of at least about pH 7.

20. The method of claim 18, wherein the target material comprises an element selected from the group consisting of atomic numbers 5, 13, 14, 22 to 25, 31, 32, 33, 34, 40 to 42, 44, 45, 49 to 52, 72 to 75, 77, 78, 80, 81, 82, 83, 92, 94, 95, and 96 and wherein the stripping solution comprises a strong base.

21. The method of claim 18, wherein the target material comprises an element selected from the group consisting of atomic numbers 5, 13, 14, 22 to 25, 31, 32, 33, 34, 40 to 42, 44, 45, 49 to 52, 72 to 75, 77, 78, 80, 81, 82, 83, 92, 94, 95, and 96, and wherein the stripping solution comprises an ethanedioate.

22. The method of claim 18, wherein the target material comprises an element selected from the group consisting of atomic numbers 5, 13, 14, 22 to 25, 31, 32, 33, 34, 40 to 42, 44, 45, 49 to 52, 72 to 75, 77, 78, 80, 81, 82, 83, 92, 94, 95, and 96, wherein the stripping solution comprises a reducing agent.

23. The method of claim 18, wherein the target material comprises an element selected from the group consisting of atomic numbers 5, 13, 14, 22 to 25, 31, 32, 33, 34, 40 to 42, 44, 45, 49 to 52, 72 to 75, 77, 78, 80, 81, 82, 83, 92, 94, 95, and 96, and wherein the stripping solution comprises an oxidizing agent.

24. The method of claim 18, wherein the removing step is performed by contacting the loaded stripping agent with a soluble fixing agent to precipitate the dissolved target materials and wherein the soluble fixing agent comprises a rare earth.

25. A method, comprising:
(a) receiving a target material-containing stream, the target material-containing stream comprising a target material and an interferor, the interferor adversely impacting rare earth precipitation of the target material;
(b) removing at least most of the interferor from the target material-containing stream to form a treated stream comprising at least most of the target material; and
(c) thereafter contacting the treated stream with at least one of a soluble and insoluble fixing agent, the fixing agent comprising a rare earth, to precipitate at least most of the target material from the treated solution.

26. The method of claim 25, wherein the interferor comprises at least one of phosphorous, fluorine, silicon, carbon, and vanadium and wherein the target material comprises an element selected from the group consisting of atomic numbers 5, 13, 22, 24, 25, 31, 32, 33, 34, 40 to 42, 44, 45, 49 to 52, 72 to 75, 77, 78, 80, 81, 82, 83, 92, 94, 95, and 96 and wherein the fixing agent comprises a lanthanoid.

27. The method of claim 25, wherein the target material comprises an element selected from the group consisting of atomic numbers 5, 13, 22, 24, 25, 31, 32, 33, 34, 40 to 42, 44, 45, 49 to 52, 72 to 75, 77, 78, 80, 81, 82, 83, 92, 94, 95, 96, and wherein the fixing agent is soluble.

28. The method of claim 25, wherein the target material comprises an element selected from the group consisting of atomic numbers 5, 13, 22, 24, 25, 31, 32, 33, 34, 40 to 42, 44, 45, 49 to 52, 72 to 75, 77, 78, 80, 81, 82, 83, 92, 94, 95, 96, and wherein the fixing agent is insoluble.

29. A method, comprising:
providing a target material-containing stream comprising a dissolved target material and dissolved valuable product, the target material being in the form of an oxyanion and the valuable product being at least one of a transition metal, aluminum, tin, and lead and in a form other than an oxyanion;
contacting the target material-containing stream with a rare earth fixing agent to precipitate at least most of the dissolved target material as a target material-containing precipitate while leaving at least most of the valuable product dissolved in a treated stream; and
separating at least most of the target material-containing precipitate from the treated stream.

30. The method of claim 29, wherein the dissolved valuable product is in the form of dissolved cations.

31. The method of claim 29, wherein the valuable product is selected from the group consisting of titanium, chromium, manganese, iron, cobalt, nickel, copper, zinc, molybdenum, a platinum group metal, a precious metal, and mixtures thereof and further comprising:
thereafter recovering at least most of the valuable product from the treated stream.
